(19) United States
(12) Patent Application Publication
(10) Pub. No.: US 2024/0069868 A1
(43) Pub. Date: Feb. 29, 2024

(54) MAC OPERATOR RELATED TO CORRECTING A COMPUTATIONAL ERROR

(71) Applicant: SK hynix Inc., Icheon-si Gyeonggi-do (KR)

(72) Inventor: Seong Ju LEE, Icheon-si Gyeonggi-do (KR)

(73) Assignee: SK hynix Inc., Icheon-si Gyeonggi-do (KR)

(21) Appl. No.: 18/188,145

(22) Filed: Mar. 22, 2023

(30) Foreign Application Priority Data
Aug. 26, 2022 (KR) 10-2022-0107476

(51) Int. Cl. G06F 7/544; G06F 7/50; G06F 7/523; G06F 11/10

(52) U.S. Cl. CPC G06F 7/5443; G06F 7/50; G06F 7/523; G06F 11/104

(57) ABSTRACT

A multiplication and accumulation (MAC) operator includes a data input circuit configured to receive first operands and second operands and configured to output the first operands and third operands, a multiplication circuit configured to generate multiplication data by performing a multiplication operation on the first operands and the third operands, an addition circuit configured to generate multiplication addition data by performing an addition operation on the multiplication data, an accumulating circuit configured to generate accumulative data by performing an accumulative addition operation on the multiplication addition data and feedback data, and an error correction circuit configured to detect a computational error in the accumulative data when a computational error occurs, and configured to output, as MAC result data, accumulative data having the computational error corrected.

### CROSS-REFERENCE TO RELATED APPLICATION

The present application claims priority under 35 U.S.C. § 119(a) to Korean application number No. 10-2022-0107476, filed in the Korean Intellectual Property Office on Aug. 26, 2022, the entire disclosure of which is incorporated herein by reference.

### BACKGROUND

### 1. Technical Field

Various embodiments of the present disclosure generally relate to a multiplication and accumulation (hereinafter referred to as “MAC”) operator and, more particularly, to a MAC operator related to correcting a computational error.

### 2. Background

Recently, there is an upsurge of interest in artificial intelligence across industries, such as finance and health care, in addition to the information technology (IT) industry. Accordingly, in various fields, the introduction of artificial intelligence, more precisely, deep learning is taken into consideration and prototyped. In general, deep learning commonly refers to a technology for effectively training deep neural networks (DNNs) or deep networks that have the increased number of layers of the existing neural networks and using the DNNs or deep networks for pattern recognition or inference.

One of backgrounds and causes of such wide interest in deep learning may be the improvement of performance of a processor that performs an operation. In order to improve performance of artificial intelligence, neural networks are trained by stacking up to several hundreds of layers of the neural networks. Such a trend recently continues for several years. For this reason, a computational load necessary for hardware that actually performs an operation has increased in geometrical progression. Furthermore, the existing hardware system in which memory and a processor are separated from each other hinders the improvement of artificial intelligence hardware performance due to the limited amount of data communication between the memory and the processor. In order to solve such a problem, recently, a PIM apparatus in which the processor and the memory have been integrated in a semiconductor chip itself tends to be used as a neural network computing device. A neural network operation in the PIM apparatus may include a matrix multiplication operation through a MAC operator. The MAC operator includes many operation circuits, and may have a high degree of integration. Accordingly, the MAC operator may be vulnerable to a voltage or temperature change, and has a quantity occurrence possibility according to particles. In such a case, a computational error may occur, and the computational error causes an error in the training and inference results of deep learning.

### SUMMARY

In an embodiment, a multiplication and accumulation (MAC) operator may include a data input circuit configured to receive first operands and second operands and configured to output the first operands and third operands, a multiplication circuit configured to generate multiplication data by performing a multiplication operation on the first operands and the third operands, an addition circuit configured to generate multiplication addition data by performing an addition operation on the multiplication data, an accumulating circuit configured to generate accumulative data by performing an accumulative addition operation on the multiplication addition data and feedback data, and an error correction circuit configured to detect a computational error in the accumulative data when a computational error occurs, and configured to output, as MAC result data, accumulative data having the computational error corrected.

### BRIEF DESCRIPTION OF THE DRAWINGS

Certain features of the disclosed technology are illustrated by various embodiments with reference to the attached drawings, in which:

FIG. 1 is a block diagram illustrating a MAC operator according to an example of the present disclosure.

FIG. 2 is a block diagram illustrating an example of a data input circuit of the MAC operator illustrated in FIG. 1.

FIG. 3 is a block diagram illustrating an example of a multiplication circuit of the MAC operator illustrated in FIG. 1.

FIG. 4 is a block diagram illustrating an example of an addition circuit of the MAC operator illustrated in FIG. 1.

FIG. 5 is a circuit diagram illustrating an example of an accumulating circuit of the MAC operator illustrated in FIG. 1.

FIG. 6 is a block diagram illustrating an example of an error correction circuit of the MAC operator illustrated in FIG. 1.

FIG. 7 is a diagram illustrating an example of a look-up table that constitutes a decoder of the error correction circuit illustrated in FIG. 6.

FIG. 8 is a circuit diagram illustrating an example of a selection output circuit of the error correction circuit illustrated in FIG. 6.

FIGS. 9 to 17 are diagrams illustrated to describe an example of an operation of a MAC operation of the MAC operator illustrated in FIG. 1.

FIGS. 18 to 21 are tables illustrated to describe the first step of a process of generating a look-up table that constitutes a decoder illustrated in FIG. 16.

FIG. 22 is a table illustrating data that has been extracted in the process of generating a look-up table, which has been described with reference to FIGS. 18 to 21.

FIGS. 23 to 26 are tables illustrated to describe the second step of the process of generating a look-up table that constitutes the decoder illustrated in FIG. 16.

FIG. 27 is a table illustrating data that has been extracted in the process of generating a look-up table, which has been described with reference to FIGS. 23 to 26.

FIGS. 28 and 29 are diagrams illustrating look-up tables that are generated by methods that have been described with reference to FIGS. 18 to 27.

FIGS. 30 and 31 are diagrams illustrated to describe an example of a computational error correction process in the error correction circuit of the MAC operator according to an example of the present disclosure.

FIGS. 32 and 33 are diagrams illustrated to describe another example of a computational error correction process in the error correction circuit of the MAC operator according to an example of the present disclosure.

FIGS. 34 and 35 are diagrams illustrated to describe still another example of a computational error correction process in the error correction circuit of the MAC operator according to an example of the present disclosure.

### DETAILED DESCRIPTION

In the following description of embodiments, it will be understood that the terms “first” and “second” are intended to identify elements, but not used to define a particular number or sequence of elements. In addition, when an element is referred to as being located “on,” “over,” “above,” “under,” or “beneath” another element, it is intended to mean relative positional relationship, but not used to limit certain cases for which the element directly contacts the other element, or at least one intervening element is present between the two elements. Accordingly, the terms such as “on,” “over,” “above,” “under,” “beneath,” “below,” and the like that are used herein are for the purpose of describing particular embodiments only and are not intended to limit the scope of the present disclosure. Further, when an element is referred to as being “connected” or “coupled” to another element, the element may be electrically or mechanically connected or coupled to the other element directly, or may be electrically or mechanically connected or coupled to the other element indirectly with one or more additional elements between the two elements. Moreover, when a parameter is referred to as being “predetermined,” it may be intended to mean that a value of the parameter is determined in advance of when the parameter is used in a process or an algorithm. The value of the parameter may be set when the process or the algorithm starts or may be set during a period in which the process or the algorithm is executed. A logic “high” level and a logic “low” level may be used to describe logic levels of electric signals. A signal having a logic “high” level may be distinguished from a signal having a logic “low” level. For example, when a signal having a first voltage corresponds to a signal having a logic “high” level, a signal having a second voltage may correspond to a signal having a logic “low” level. In one embodiment, the logic “high” level may be set as a voltage level which is higher than a voltage level of the logic “low” level. Meanwhile, logic levels of signals may be set to be different or opposite according to embodiment. For example, a certain signal having a logic “high” level in one embodiment may be set to have a logic “low” level in another embodiment.

Various embodiments of the present disclosure will be described hereinafter in detail with reference to the accompanying drawings. However, the embodiments described herein are for illustrative purposes only and are not intended to limit the scope of the present disclosure.

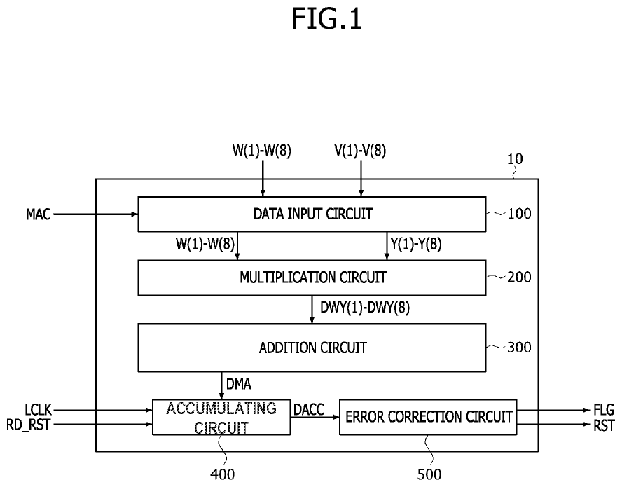

FIG. 1 is a block diagram illustrating a MAC operator 10 according to an example of the present disclosure. Referring to FIG. 1, the MAC operator 10 may receive first operands W(1) to W(8) and second operands V(1) to V(8). The number of first operands W(1) to W(8) and the number of second operands V(1) to V(8) that are input to the MAC operator 10 may be determined depending on an operation processing capability of the MAC operator 10. Hereinafter, a case in which eight first operands W(1) to W(8) and eight second operands V(1) to V(8) are input to the MAC operator 10 is taken as an example. In an example, the first operands W(1) to W(8) and the second operands V(1) to V(8) may be weight data and vector data that are used in a multi-layer perceptron (MLP) neural network operation, respectively. In the following several examples, a case in which each of each of the first operands W(1) to W(8) and each of the second operands V(1) to V(8) has a signed fixed-point format may be premised. Accordingly, each of the first operands W(1) to W(8) and each of the second operands V(1) to V(8) may be constituted with a sign bit, an integer part, and a fractional part, and each of the second operands V(1) to V(8) may be constituted with a sign bit, an integer part, and a fractional part. The MAC operator 10 may perform a matrix multiplication operation on the first operands W(1) to W(8) and the second operands V(1) to V(8). The MAC operator 10 may output MAC result data RST. The MAC operator 10 may include a data input circuit 100, a multiplication circuit 200, an addition circuit 300, an accumulating circuit 400, and an error correction circuit 500.

The data input circuit 100 may receive the first operands W(1) to W(8) and the second operands V(1) to V(8). The data input circuit 100 may output the first operands W(1) to W(8) and third operands Y(1) to Y(8). The data input circuit 100 may generate each of the third operands Y(1) to Y(8) by multiplying each of the second operands V(1) to V(8) by constant number data. In this example, the constant number data may be defined as a binary stream of a natural number. The data input circuit 100 may receive a MAC signal MAC by synchronizing time points at which the first operands W(1) to W(8) and the third operands Y(1) to Y(8) are output. The MAC signal MAC may perform substantially the same function as a clock signal within the data input circuit 100. The data input circuit 100 may output the first operands W(1) to W(8) and the third operands Y(1) to Y(8) in synchronization with a pulse of the MAC signal MAC.

The multiplication circuit 200 may receive the first operands W(1) to W(8) and the third operands Y(1) to Y(8) that are output by the data input circuit 100. The multiplication circuit 200 may generate multiplication data DWY(1) to DWY(8) by performing multiplication operations on the first operands W(1) to W(8) and the third operands Y(1) to Y(8). The first multiplication data DWY(1), among the multiplication data DWY(1) to DWY(8), may be generated as the results of a multiplication operation for the first operand W(1) and the second operand Y(1). The second multiplication data DWY(2) may be generated as the results of a multiplication operation for the first operand W(2) and the second operand Y(2). In the same way, the eighth multiplication data DWY(8) may be generated as the results of a multiplication operation for the first operand W(8) and the second operand Y(8).

The addition circuit 300 may receive the multiplication data DWY(1) to DWY(8) that are output by the multiplication circuit 200. The addition circuit 300 may generate multiplication addition data DMA by performing addition operations on the multiplication data DWY(1) to DWY(8). Due to carry bits that are generated in an addition operation process of the addition circuit 300, the multiplication addition data DMA may have the number of bits that has been more increased than the number of bits of each of the multiplication data DWY(1) to DWY(8).

The accumulating circuit 400 may receive the multiplication addition data DMA that is output by the addition circuit 300. The accumulating circuit 400 may generate accumulative data DACC by performing an accumulative operation on the multiplication addition data DMA. The accumulative operation in the accumulating circuit 400 may be performed on the multiplication addition data DMA and latch data that has been latched in the accumulating circuit 400. The latch data may correspond to the accumulative data DACC that is generated in a previous MAC operation in the MAC operator 10. The accumulating circuit 400 may receive a latch clock signal LCLK and a MAC result read signal RD_RST. The accumulating circuit 400 may perform a latch operation on the accumulative data DACC in synchronization with the latch clock signal LCLK. The accumulating circuit 400 may output the accumulative data DACC in response to the input of the MAC result read signal RD_RST having a first logic level (e.g., a logic high).

The error correction circuit 500 may detect a computational error in the accumulative data DACC that is output by the accumulating circuit 400. If a computational error has not occurred as a result of the detection of a computational error, the error correction circuit 500 may output the accumulative data DACC as the MAC result data RST. If a computational error has occurred as a result of the detection of a computational error, the error correction circuit 500 may perform a computational error correction operation on the accumulative data DACC. The error correction circuit 500 may generate flag data FLG based on a computational error detection operation and a computational error correction operation. The flag data FLG may have information with regard to a bit location at which a computational error has occurred and a computational error format if the computational error has occurred in the accumulative data DACC. Furthermore, the error correction circuit 500 may output, as the MAC result data RST, results that are generated by performing a computational error detection operation and a computational error correction operation on the accumulative data DACC.

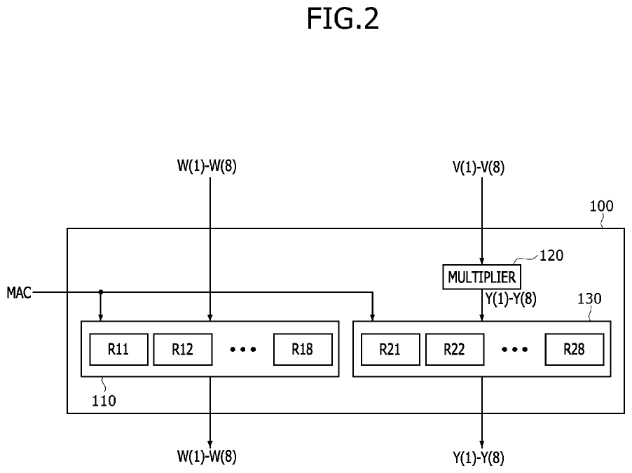

FIG. 2 is a block diagram illustrating an example of the data input circuit 100 of the MAC operator 10 illustrated in FIG. 1. Referring to FIG. 2, the data input circuit 100 may include a first register circuit 110, a multiplier 120, and a second register circuit 130. The first register circuit 110 may include eight first registers R11 to R18. The number of first registers R11 to R18 that constitute the first register circuit 110 may be the same as the number of first operands W(1) to W(8). The second register circuit 130 may include a plurality of, for example, eight second registers R21 to R28. The number of second registers R21 to R28 that constitute the second register circuit 130 may be the same as the number of third operands Y(1) to Y(8).

The first registers R11 to R18 of the first register circuit 110 may receive the first operands W(1) to W(8), respectively. For example, the first register R11 may receive the first operand W(1). The first register R12 may receive the first operand W(2). Furthermore, the first register R18 may receive the first operand W(8). The first registers R11 to R18 may receive the MAC signal MAC in common. The first registers R11 to R18 may output the first operands W(1) to W(8) in response to the input of the MAC signal MAC having a first logic level (e.g., a logic high). The multiplier 120 may receive the second operands V(1) to V(8). The multiplier 120 may generate each of the third operands Y(1) to Y(8) by performing a multiplication operation on each of the second operands V(1) to V(8) and constant number data. The second registers R21 to R28 of the second register circuit 130 may receive the third operands Y(1) to Y(8), respectively. For example, the second register R21 may receive the third operand Y(1). The second register R22 may receive the third operand Y(2). Furthermore, the second register R28 may receive the third operand Y(8). The second registers R21 to R28 may receive the MAC signal MAC in common. The second registers R21 to R28 may output the third operands Y(1) to Y(8) in response to the input of the MAC signal MAC having a first logic level (e.g., a logic high).

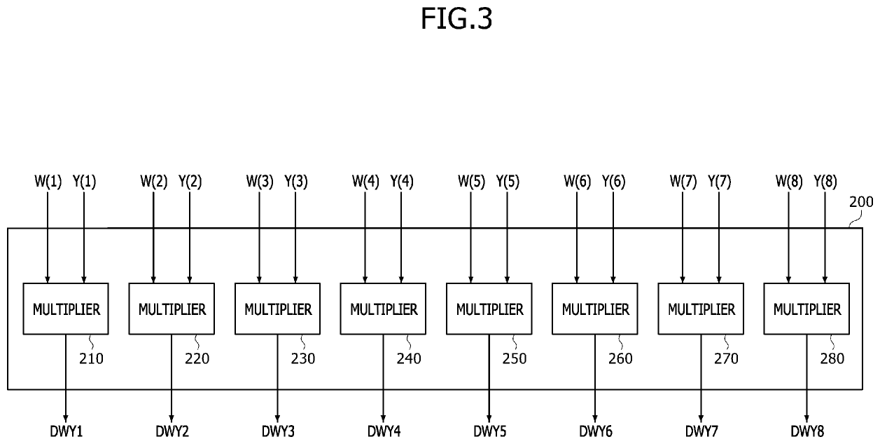

FIG. 3 is a block diagram illustrating an example of the multiplication circuit 200 of the MAC operator 10 illustrated in FIG. 1. Referring to FIG. 3, the multiplication circuit 200 may include a plurality of, for example, first to eighth multipliers 210 to 280. The number of multipliers 210 to 280 that constitute the multiplication circuit 200 may be the same as the number of first operands W(1) to W(8) (or the number of third operands Y(1) to Y(8)). Each of the multipliers 210 to 280 may receive each of the first operands W(1) to W(8) and each of the third operands Y(1) to Y(8), and may perform a multiplication operation on each of the first operands W(1) to W(8) and each of the third operands Y(1) to Y(8). According to the illustrated drawing, the first multiplier 210 may receive the first operand W(1) and the third operand Y(1), may perform a multiplication operation on the first operand W(1) and the third operand Y(1), and may output a result of the execution of the multiplication operation as the first multiplication data DWY1. The second multiplier 220 may receive the first operand W(2) and the third operand Y(2), may perform a multiplication operation on the first operand W(2) and the third operand Y(2), and may output a result of the execution of the multiplication operation as second multiplication data DWY2. Likewise, the eighth multiplier 280 may receive the first operand W(8) and the third operand Y(8), may perform a multiplication operation on the first operand W(8) and the third operand Y(8), and may output a result of the execution of the multiplication operation as the eighth multiplication data DWY8.

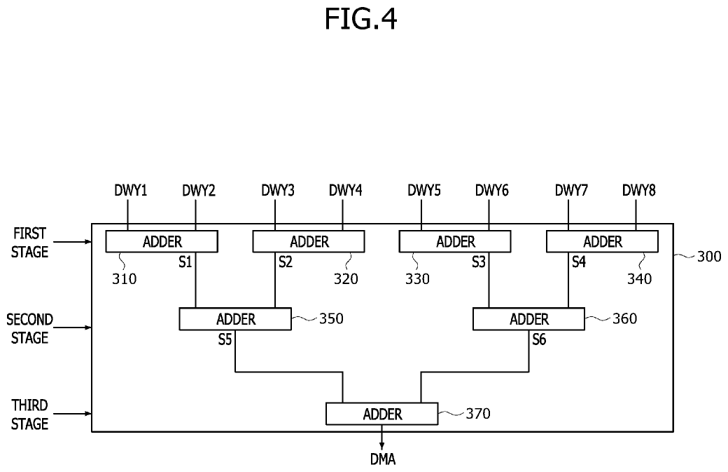

FIG. 4 is a block diagram illustrating an example of the addition circuit 300 of the MAC operator 10 illustrated in FIG. 1. Referring to FIG. 4, the addition circuit 300 may be constructed by disposing a plurality of adders 310 to 370 in the form of a hierarchical structure, such as a tree. In this example, the addition circuit 300 may be constituted with seven half-adders. However, this is merely an example, and the addition circuit 300 may be constituted with various combinations of full-adders and half-adders. According to the illustrated drawing, the first to fourth adders 310 to 340 may be disposed at a first stage of the addition circuit 300. The fifth and sixth adders 350 and 360 may be disposed at a second stage of the addition circuit 300. The seventh adder 370 may be disposed at a third stage of the addition circuit 300.

The first adder 310 of the first stage may receive the first and second multiplication data DWY1 and DWY2 from the first and second multipliers (210 and 220 in FIG. 3) of the multiplication circuit (200 in FIG. 3). The first adder 310 may generate first addition data S1 by performing an addition operation on the first and second multiplication data DWY1 and DWY2. The second adder 320 of the first stage may receive the third and fourth multiplication data DWY3 and DWY4 from the third and fourth multipliers (230 and 240 in FIG. 3) of the multiplication circuit (200 in FIG. 3). The second adder 320 may generate second addition data S2 by performing an addition operation on the third and fourth multiplication data DWY3 and DWY4. The third adder 330 of the first stage may receive the fifth and sixth multiplication data DWY5 and DWY6 from the fifth and sixth multipliers (250 and 260 in FIG. 3) of the multiplication circuit (200 in FIG. 3). The third adder 330 may generate third addition data S3 by performing an addition operation on the fifth and sixth multiplication data DWY5 and DWY6.

The fifth adder 350 of the second stage may receive the first addition data S1 and the second addition data S2 from the first adder 310 and second adder 320 of the first stage, respectively. The fifth adder 350 may generate fifth addition data S5 by performing an addition operation on the first addition data S1 and the second addition data S2. The sixth adder 360 of the second stage may receive the third addition data S3 and the fourth addition data S4 from the third adder 330 and fourth adder 340 of the first stage, respectively. The sixth adder 360 may generate sixth addition data S6 by performing an addition operation on the third addition data S3 and the fourth addition data S4. The seventh adder 370 of the third stage may receive the fifth addition data S5 and the sixth addition data S6 from the fifth adder 350 and sixth adder 360 of the second stage, respectively. The seventh adder 370 may generate the multiplication addition data DMA by performing an addition operation on the fifth addition data S5 and the sixth addition data S6.

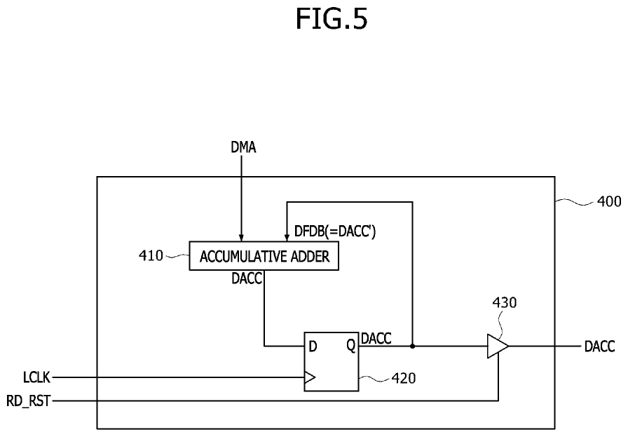

FIG. 5 is a circuit diagram illustrating an example of the accumulating circuit 400 of the MAC operator 10 illustrated in FIG. 1. Referring to FIG. 5, the accumulating circuit 400 may include an accumulative adder 410, a latch circuit 420, and an output buffer 430. In an example, the accumulative adder 410 may be constituted with a half-adder. In an example, the latch circuit 420 may be constituted with a flip-flop. In an example, the output buffer 430 may be constituted with a 3-state buffer. The accumulative adder 410 may receive the multiplication addition data DMA that is output by the addition circuit (300 in FIG. 4) and feedback data DFDB through a first input terminal and a second input terminal, respectively. The feedback data DFDB may mean accumulative data DACC′ that is output by the latch circuit 420 and that is fed back to the accumulative adder 410. The accumulative data DACC′ that is provided as the feedback data DFDB is different from the accumulative data DACC that is output by the accumulative adder 410. That is, the accumulative data DACC′ that constitutes the feedback data DFDB may correspond to the accumulative data DACC′ that is generated in a previous MAC operation process and that is latched in the latch circuit 420. The accumulative adder 410 may generate the accumulative data DACC by performing an addition operation on the multiplication addition data DMA and the feedback data DFDB. The accumulative adder 410 may transmit the accumulative data DACC to the latch circuit 420.

The latch circuit 420 may include an input terminal D, an output terminal Q, and a clock terminal. The input terminal D of the latch circuit 420 may be connected to an output terminal of the accumulative adder 410. The output terminal Q of the latch circuit 420 may be connected to the second input terminal of the accumulative adder 410 and the input terminal of the output buffer 430. The latch circuit 420 may receive the latch clock signal LCLK through the clock terminal. The latch circuit 420 may latch the accumulative data DACC that is transmitted by the accumulative adder 410 through the input terminal D. The latch circuit 420 may output the accumulative data DACC that has been latched through the output terminal Q, in response to the input of the latch clock signal LCLK having a first logic level (e.g., a logic high). The accumulative data DACC that is output by the latch circuit 420 may be transmitted to the second input terminal of the accumulative adder 410, and may be used as the feedback data DFDB in a next MAC operation.

The output buffer 430 may have an input terminal that is connected to the output terminal Q of the latch circuit 420, an enable terminal, and an output terminal. The output buffer 430 may receive the accumulative data DACC that is output by the latch circuit 420 through the input terminal. The output buffer 430 may receive the MAC result read signal RD_RST through the enable terminal. The output buffer 430 may output the accumulative data DACC through the output terminal, in response to the input of the MAC result read signal RD_RST having a first logic level (e.g., a logic high). The output buffer 430 might not output data through the output terminal, in response to the input of the MAC result read signal RD_RST having a second logic level (e.g., a logic low).

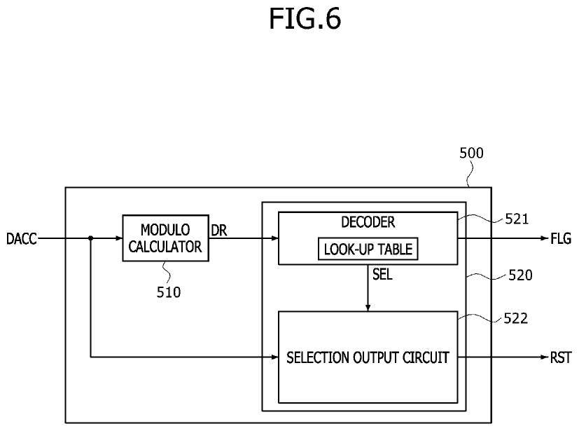

FIG. 6 is a block diagram illustrating an example of the error correction circuit 500 of the MAC operator 10 illustrated in FIG. 1. Referring to FIG. 6, the error correction circuit 500 may include a modulo calculator 510 and an error corrector 520. The error corrector 520 may include a decoder 521 and a selection output circuit 522. The modulo calculator 510 may receive the accumulative data DACC from the accumulating circuit (400 in FIG. 5). The modulo calculator 510 may output remaining data DR that is generated by dividing the accumulative data DACC by constant number data. In this case, the constant number data may be the same as the constant number data that has been multiplied with the second operands V(1) to V(8) after the start of the multiplication operation in the multiplier (120 in FIG. 2) that constitutes the data input circuit (100 in FIG. 2). The modulo calculator 510 may transmit the remaining data DR to the decoder 521 of the error corrector 520.

The decoder 521 of the error corrector 520 may generate the flag data FLG and selection data SEL based on the remaining data DR that is transmitted by the modulo calculator 510. In an example, the decoder 521 may generate the flag data FLG and the selection data SEL by using a look-up table. A computational error bit that has been previously calculated based on remaining data that has been generated by dividing the accumulative data DACC by the constant number data and the flag data FLG and the selection data SEL that are determined based on the computational error bit may be stored in the look-up table. As described with reference to FIG. 1, if a computational error has occurred in the accumulative data DACC, the flag data FLG may have a bit location at which the computational error has occurred and information with regard to a computational error format. The selection data SEL may control a selective data output operation in the selection output circuit 522. The selection data SEL may be constituted with a binary stream having the same number of bits as the number of bits of the accumulative data DACC.

The selection output circuit 522 of the error corrector 520 may receive the accumulative data DACC that is output by the output buffer (430 in FIG. 5) of the accumulating circuit (400 in FIG. 5) and the selection data SEL that is output by the decoder 521. The selection output circuit 522 may perform a computational error correction operation based on the selection data SEL. In an example, the selection output circuit 522 may perform the computational error correction operation by inverting a binary value of a bit that is designated by the selection data SEL, among the bits of the accumulative data DACC. The selection output circuit 522 may output, as the MAC result data RST, data a computational error of which has been removed from the accumulative data DACC.

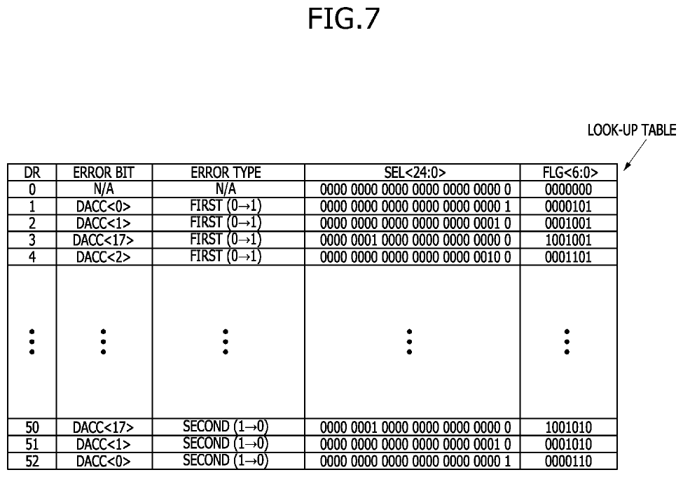

FIG. 7 is a diagram illustrating an example of a look-up table that is included in the decoder 521 of the error correction circuit 500 illustrated in FIG. 6. In FIG. 7, the remaining data DR has been indicated as a decimal value, but this is merely for the easiness of a description. The remaining data DR is substantially stored in the look-up table as a binary stream format that corresponds to a decimal value. Referring to FIG. 7, when the constant number data is a decimal number “K”, the remaining data DR that is output by the modulo calculator 510 may have a value from a decimal number “0” to a decimal number “K−1”. In this example, a case in which “K” is “53” and the accumulative data DACC is constituted with 25 bits may be taken as an example. The look-up table may have first to fifth columns. The remaining data DR may be disposed in the first column. An error bit may be disposed in the second column. A computational error format may be disposed in the third column. Selection data SEL<24:0> may be disposed in the fourth column. Furthermore, flag data FLG<7:0> may be disposed in the fifth column. That is, values of the error bit, the computational error format, the selection data, and the flag data that correspond to one remaining data DR may be disposed in the second to fourth columns, respectively.

According to the example illustrated in FIG. 7, when the remaining data DR “0” is transmitted by the modulo calculator 510, the selection data SEL<24:0> all bits of which are “0” and the flag data FLG<6:0> of “0000000” may be determined as output data. Lower 2 bits of the flag data FLG<6:0> may indicate the computational error format, and upper 5 bits thereof may indicate computational error bits. When the flag data FLG<6:0> is “0000000”, “00”, that is, lower 2 bits of “0000000”, may indicate that a computational error has not occurred, and “00000”, that is, upper 5 bits thereof, may indicate that a computational error bit is not present. When the remaining data DR “1” is transmitted by the modulo calculator 510, the selection data SEL<24:0> only the first bit of which, that is, the lowest, is “1” and the remaining bits thereof are “0” and the flag data FLG<6:0> of “0000101” may be determined as the output data. “01”, that is, lower 2 bits of the flag data FLG<6:0>, may indicate an error of a first format, that is, that an error in which normal data “0” has changed into “1” has occurred. “00001”, that is, upper 5 bits of the flag data FLG<6:0>, may indicate that a computational error bit is the first bit DACC<0>, that is, the lowest of the accumulative data DACC.

When the remaining data DR “2” is transmitted by the modulo calculator 510, the selection data SEL<24:0> only the second bit of which is “1” and the remaining bits thereof are “0” and the flag data FLG<6:0> of “0001001” may be determined as the output data. “01”, that is, lower 2 bits of the flag data FLG<6:0>, may indicate that an error of the first format has occurred, and “00010”, that is, upper 5 bits of the flag data FLG<6:0>, may indicate that a computational error bit is the second bit DACC<1> of the accumulative data DACC. When the remaining data DR “3” is transmitted by the modulo calculator 510, the selection data SEL<24:0> only the eighteenth bit of which is “1” and the remaining bits thereof are “0” and the flag data FLG<6:0> of “1001001” may be determined as the output data. “01”, that is, lower 2 bits of the flag data FLG<6:0>, may indicate that an error of the first format has occurred, and “10010”, that is, upper 5 bits of the flag data FLG<6:0>, may indicate that a computational error bit is the eighteenth bit DACC<17> of the accumulative data DACC. When the remaining data DR “4” is transmitted by the modulo calculator 510, the selection data SEL<24:0> only the third bit of which is “1” and the remaining bits thereof are “0” and the flag data FLG<6:0> of “0001101” may be determined as the output data. “01”, that is, lower 2 bits of the flag data FLG<6:0>, may indicate that an error of the first format has occurred, and “00011”, that is, upper 5 bits of the flag data FLG<6:0>, may indicate that a computational error bit is the third bit DACC<2> of the accumulative data DACC.

When the remaining data DR “50” is transmitted by the modulo calculator 510, the selection data SEL<24:0> only the eighteenth bit of which is “1” and the remaining bits thereof are “0” and the flag data FLG<6:0> of “1001010” may be determined as the output data. “10”, that is, lower 2 bits of the flag data FLG<6:0>, may indicate an error of a second format, that is, that an error in which normal data “1” has changed into “0” has occurred. “10010”, that is, upper 5 bits of the flag data FLG<6:0>, may indicate that a computational error bit is the eighteenth bit DACC<17> of the accumulative data DACC. When the remaining data DR “51” is transmitted by the modulo calculator 510, the selection data SEL<24:0> only the second bit of which is “1” and the remaining bits thereof are “0” and the flag data FLG<6:0> of “0001010” may be determined as the output data. “10”, that is, lower 2 bits of the flag data FLG<6:0>, may indicate that an error of the second format has occurred, and “00010”, that is, upper 5 bits of the flag data FLG<6:0>, may indicate that a computational error bit is the second bit DACC<1> of the accumulative data DACC. When the remaining data DR “52” is transmitted by the modulo calculator 510, the selection data SEL<24:0> only the first bit of which is “1” and the remaining bits thereof are “0” and the flag data FLG<6:0> of “0000110” may be determined as the output data. “10”, that is, lower 2 bits of the flag data FLG<6:0>, may indicate that an error of the second format has occurred, and “00001”, that is, upper 5 bits of the flag data FLG<6:0>, may indicate a computational error bit is the first bit DACC<0> of the accumulative data DACC.

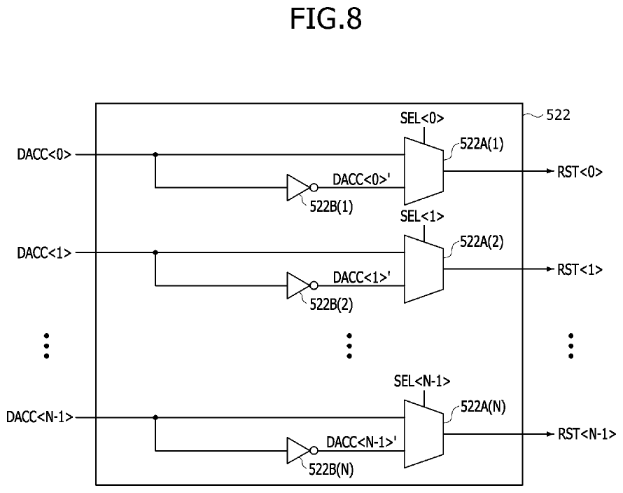

FIG. 8 is a circuit diagram illustrating an example of the selection output circuit 522 of the error correction circuit 500 illustrated in FIG. 6. Referring to FIG. 8, the selection output circuit 522 of the error corrector 520 may receive the accumulative data DACC that is output by the output buffer (430 in FIG. 5) of the accumulating circuit (400 in FIG. 5) and the selection data SEL that is output by the decoder 521. The selection output circuit 522 may output, as the MAC result data RST, data in which a computational error has been removed from the accumulative data DACC, based on the selection data SEL. As illustrated in FIG. 8, the selection output circuit 522 may include a plurality of selection outputters 522A(1) to 522A(N) and a plurality of inverters 522B(1) to 522B(N). Each of the number of selection outputters 522A(1) to 522A(N) and the number of inverters 522B(1) to 522B(N) may be the same as the number of bits of the accumulative data DACC. As illustrated in the drawing, if the accumulative data DACC is constituted with N bits (N is a natural number equal to or greater than 2), the selection output circuit 522 may be constituted with N selection outputters 522A(1) to 522A(N) and N inverters 522B(1) to 522B(N).

Each of the selection outputters 522A(1) to 522A(N) may have a first input terminal, a second input terminal, a selection terminal, and an output terminal. The selection outputters 522A(1) to 522A(N) may receive bits of the accumulative data DACC through the first input terminals, respectively. Furthermore, the inverters 522B(1) to 522B(N) may receive bits of the accumulative data DACC through input terminals, respectively. The selection outputters 522A(1) to 522A(N) may receive inverted bits of the accumulative data DACC that are output by the inverters 522B(1) to 522B(N) through the second input terminals, respectively. The selection outputters 522A(1) to 522A(N) may receive bits of the selection data SEL, respectively, through the selection terminals. The selection outputters 522A(1) to 522A(N) may output bits of the MAC result data RST, respectively, through the output terminals.

According to the illustrated drawing, the first inverter 522B(1) may receive the first bit DACC<0>, that is, the lowest of the accumulative data, and may output an inverted first bit DACC<0>′. The first selection outputter 522A(1) may receive the first bit DACC<0> and inverted first bit DACC<0>′ of the accumulative data DACC through the first input terminal and the second input terminal, respectively. The first selection outputter 522A(1) may output one of the first bit DACC<0> and inverted first bit DACC<0>′ of the accumulative data DACC as the first bit RST<0> of the MAC result data RST through the output terminal based on a value of the first bit SEL<0> of the selection data SEL. The second inverter 522B(2) may receive the second bit DACC<1> of the accumulative data, and may output an inverted second bit DACC<1>′. The second selection outputter 522A(2) may receive the second bit DACC<1> and inverted second bit DACC<1>′ of the accumulative data DACC through the first input terminal and the second input terminal, respectively. The second selection outputter 522A(2) may output one of the second bit DACC<1> and inverted second bit DACC<1>′ of the accumulative data DACC as the second bit RST<1> of the MAC result data RST through the output terminal based on a value of the second bit SEL<1> of the selection data SEL. The N-th inverter 522B(N) may receive the N-th bit DACC<N−1> of the accumulative data, and may output an inverted N-th bit DACC<N−1>′. The N-th selection outputter 522A(N) may receive the N-th bit DACC<N−1> and inverted N-th bit DACC<N−1>′ of the accumulative data DACC through the first input terminal and the second input terminal, respectively. The N-th selection outputter 522A(N) may output one of the N-th bit DACC<N−1> and inverted N-th bit DACC<N−1>′ of the accumulative data DACC as the N-th bit RST<N−1> of the MAC result data RST through the output terminal based on a value of the N-th bit SEL<N−1> of the selection data SEL.

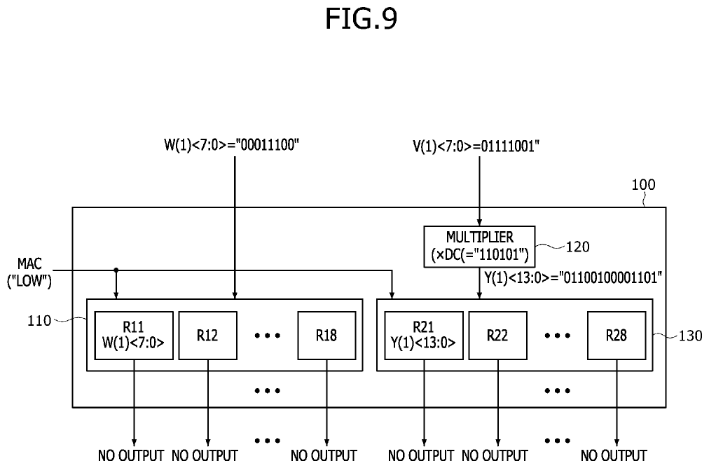

FIGS. 9 to 17 are diagrams illustrated to describe an example of an operation of a MAC operation of the MAC operator 10 illustrated in FIG. 1. In this example, it may be premised that each of the first operands W(1) to W(8) and the second operands V(1) to V(8) includes 8 bits. In such a case, in order to simplify a description, it may be premised that each of the first operands W(1) to W(8) and the second operands V(1) to V(8) is constituted with a sign bit of 1 bit and an integer part of 7 bits. Hereinafter, a case in which constant number data that is used as a multiplicand in the multiplier 120 of the data input circuit 100 is set as “110101” (i.e., a decimal number “53”), the 1^{st} first operand W(1)<7:0> of the first operands W(1)<7:0>-W(8)<7:0> is “00011100” (the decimal number+28), and the 1^{st} second operand V(1)<7:0> of the second operands V(1)<7:0>-V(8)<7:0> is “01111001” (a decimal number+121) may be taken as an example.

First, referring to FIG. 9, “00011100”, that is, the first operand W(1)<7:0>, may be input to the first register R11 of the first register circuit 110. In the state in which the MAC signal MAC that is transmitted to the first register circuit 110 maintains the logic level of a logic low LOW, the first register R11 might not output the first operand W(1)<7:0>. “01111001”, that is, the second operand V(1)<7:0>, may be input to the multiplier 120. The multiplier 120 may perform a multiplication operation on the second operand V(1)<7:0> and the constant number data DC, that is, an operation of “01111001”×“110101”. The multiplier 120 may output, as a third operand Y(1)<13:0>, “01100100001101” (a decimal number +6,413) that is generated as the results of the multiplication operation. The multiplier 120 may transmit the third operand Y(1)<13:0> to the second register R21 of the second register circuit 130. Furthermore, in the state in which the MAC signal MAC maintains the logic level of a logic low LOW, the second register R21 might not output the third operand Y(1)<13:0>.

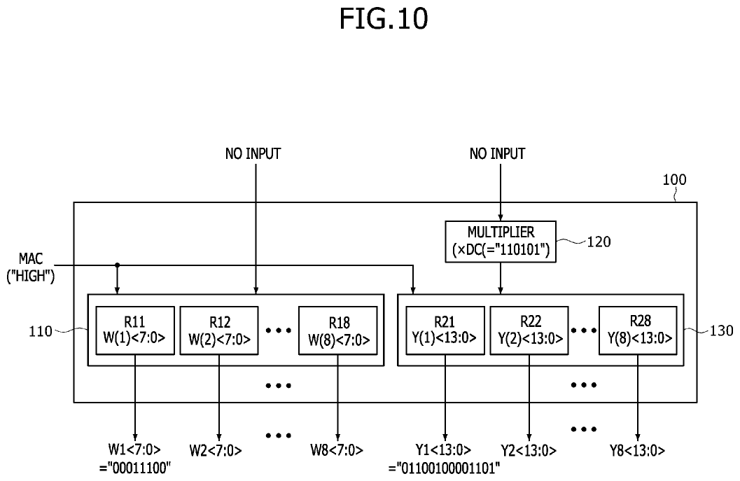

Referring to FIG. 10, the remaining first operands W(2)<7:0>-W(8)<7:0> may be input to the remaining first registers R12 to R18, respectively, in the same manner as the case of the first operand W(1)<7:0>. Furthermore, in the same manner as the case of the third operand Y(1)<13:0>, the remaining third operands Y(2)<13:0>-Y(8)<13:0> may be generated by the multiplier 120, and may be input to the second registers R22 to R28, respectively. When the logic level of the MAC signal MAC that is transmitted to the data input circuit 100 is changed into a logic high HIGH, the first registers R11 to R18 may output the first operands W(1)<7:0>-W(8)<7:0>, respectively. Furthermore, the second registers R21 to R28 may output the third operands Y(1)<13:0>-Y(8)<13:0>, respectively. The first operand W(1)<7:0> may have a value of “00011100” (a decimal number+28), whereas the third operand Y(1)<13:0> may have a value of “01100100001101” (the decimal number +6,413).

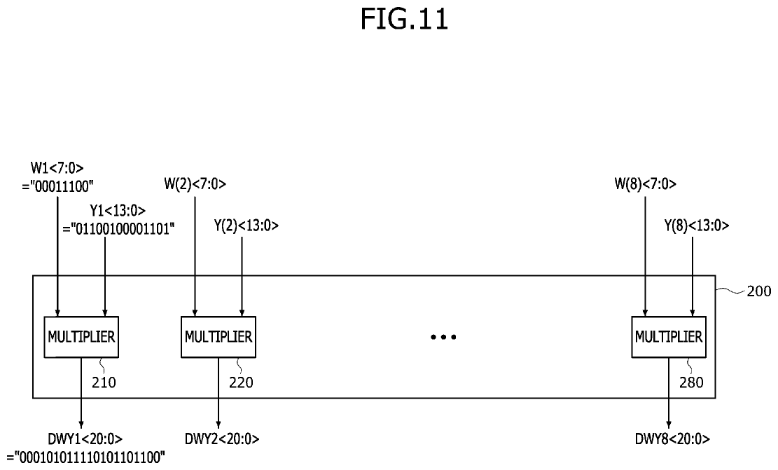

Referring to FIG. 11, the first operand W(1)<7:0> and the third operand Y(1)<13:0> that are output by the data input circuit 100 may be input to the first multiplier 210 of the multiplication circuit 200. A first operand W(2)<7:0> and a third operand Y(2)<13:0> that are output by the data input circuit 100 may be input to the second multiplier 220 of the multiplication circuit 200. A first operand W(8)<7:0> and a third operand Y(8)<13:0> that are output by the data input circuit 100 may be input to the eighth multiplier 280 of the multiplication circuit 200. The first multiplier 210 of the multiplication circuit 200 may perform a multiplication operation on “00011100” (a decimal number+28), that is, the first operand W(1)<7:0>, and “01100100001101” (the decimal number+6,413), that is, the third operand Y(1)<13:0>. The first multiplier 210 of the multiplication circuit 200 may output, as first multiplication data DWY1<20:0>, “000101011110101101100” (a decimal number+179,564) that is generated as the results of the multiplication operation. In the same manner, the second multiplier 220 may output the second multiplication data DWY2<20:0>. Furthermore, the eighth multiplier 280 may output eighth multiplication data DWY8<20:0>.

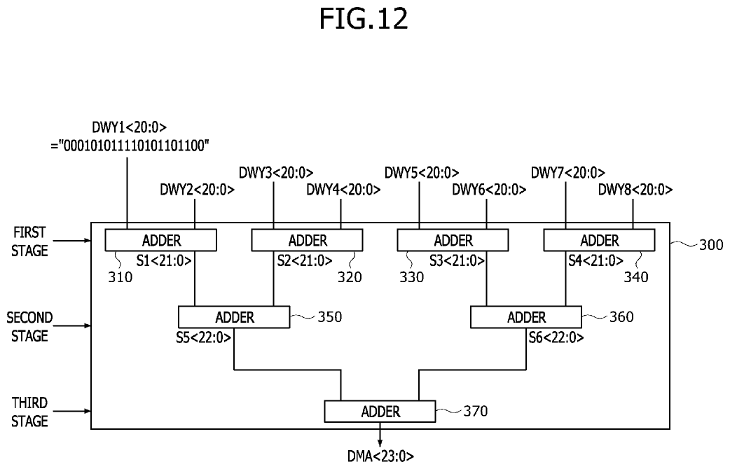

Referring to FIG. 12, the first adder 310 of the first stage of the addition circuit 300 may receive the first multiplication data DWY1<20:0> and the second multiplication data DWY2<20:0> from the first multiplier 210 and second multiplier 220 of the multiplication circuit (200 in FIG. 11), respectively. The first adder 310 may output the first addition data S1<21:0> by performing an addition operation on the first multiplication data DWY1<20:0> and the second multiplication data DWY2<20:0>. Due to a carry bit that is generated after the start of an addition operation in the first adder 310, the first addition data S1<21:0> may be constituted with 22 bits. In a similar manner, the second adder 320 of the first stage may output the second addition data S2<21:0> by performing an addition operation on third multiplication data DWY3<20:0> and fourth multiplication data DWY4<20:0>. The third adder 330 of the first stage may output the third addition data S3<21:0> by performing an addition operation on fifth multiplication data DWY5<20:0> and sixth multiplication data DWY6<20:0>. Furthermore, the fourth adder 340 of the first stage may output the fourth addition data S4<21:0> by performing an addition operation on seventh multiplication data DWY7<20:0> and eighth multiplication data DWY8<20:0>.

The fifth adder 350 of the second stage may receive the first addition data S1<21:0> and the second addition data S2<21:0> from the first adder 310 and second adder 320 of the first stage, respectively. The fifth adder 350 may output the fifth addition data S5<22:0> by performing an addition operation on the first addition data S1<21:0> and the second addition data S2<21:0>. Due to a carry bit that is generated after the start of an addition operation in the fifth adder 350, the fifth addition data S5<22:0> may be constituted with 23 bits. The sixth adder 360 of the second stage may receive the third addition data S3<21:0> and the fourth addition data S4<21:0> from the third adder 330 and fourth adder 340 of the first stage, respectively. The sixth adder 360 may output the sixth addition data S6<22:0> by performing an addition operation on the third addition data S3<21:0> and the fourth addition data S4<21:0>.

The seventh adder 370 of the third stage may receive the fifth addition data S5<22:0> and the sixth addition data S6<22:0> from the fifth adder 350 and sixth adder 360 of the second stage, respectively. The seventh adder 370 may output the multiplication addition data DMA<23:0> by performing an addition operation on the fifth addition data S5<22:0> and the sixth addition data S6<22:0>. Due to a carry bit that is generated after the start of an addition operation in the seventh adder 370, the multiplication addition data DMA<23:0> may be constituted with 24 bits.

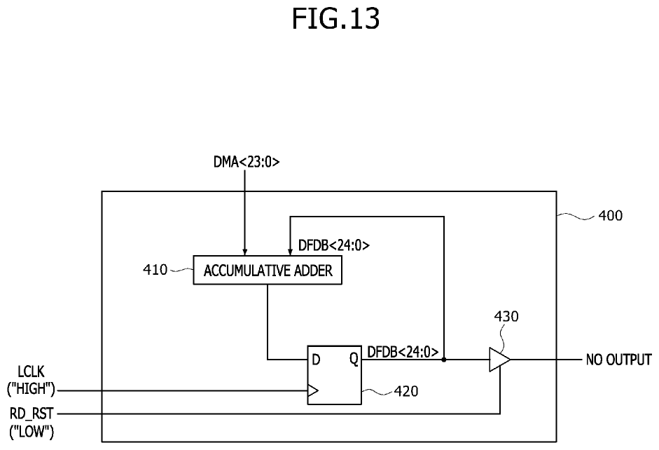

Referring to FIG. 13, the accumulative adder 410 of the accumulating circuit 400 may receive the multiplication addition data DMA<23:0> that are output by the addition circuit (300 in FIG. 12) through the first input terminal. The latch circuit 420 of the accumulating circuit 400 may output, as the feedback data DFDB<24:0>, data that has been latched in the latch circuit 420 through the output terminal Q in response to the input of the latch clock signal LCLK having a logic high HIGH. The accumulative adder 410 may receive the feedback data DFDB<24:0> from the latch circuit 420 through the second input terminal.

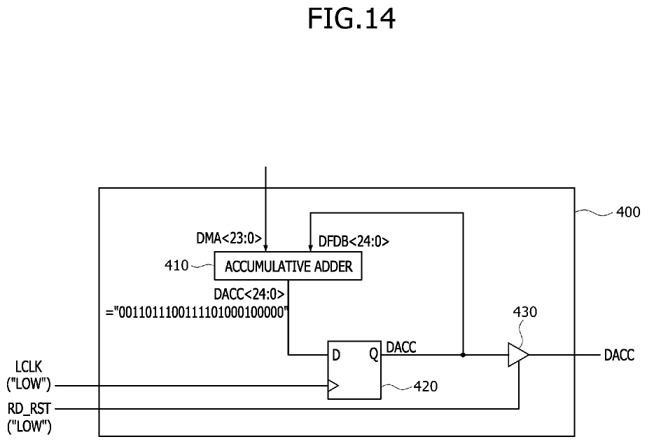

Referring to FIG. 14, the accumulative adder 410 of the accumulating circuit 400 may generate the accumulative data DACC<24:0> by performing an accumulative addition operation on the multiplication addition data DMA<23:0> and the feedback data DFDB<24:0>. The accumulative data DACC<24:0> may be constituted with 25 bits identically with the feedback data DFDB<24:0>. Hereinafter, it is assumed that when a computational error does not occur in a process of performing the multiplication operations in the multiplication circuit (200 in FIG. 11), the addition operations in the addition circuit (300 in FIG. 12), and the accumulative addition operation in the accumulative adder 410, the accumulative data DACC<24:0> that is output by the accumulative adder 410 normally is “0011011100111101000100000” (a decimal number +7,240,224). The accumulative data DACC<24:0> that are output by the accumulative adder 410, that is, “0011011100111101000100000”, are transmitted to the input terminal D of the latch circuit 420.

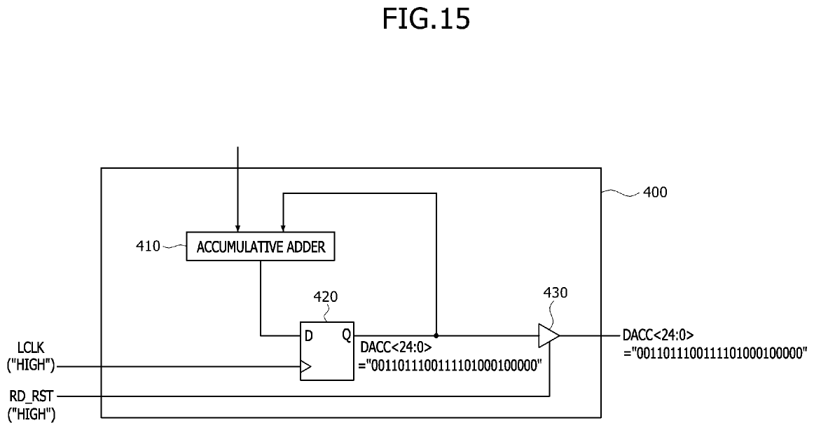

Referring to FIG. 15, the latch circuit 420 of the accumulating circuit 400 may output the accumulative data DACC<24:0>, that is, “0011011100111101000100000”, through the output terminal Q in response to the input of the latch clock signal LCLK having a logic high HIGH. The output buffer 430 of the accumulating circuit 400 may receive the accumulative data DACC<24:0> from the latch circuit 420 through the input terminal. The output buffer 430 may output the accumulative data DACC<24:0>, that is, “0011011100111101000100000”, through the output terminal in response to the input of the MAC result read signal RD_RST having a logic high HIGH.

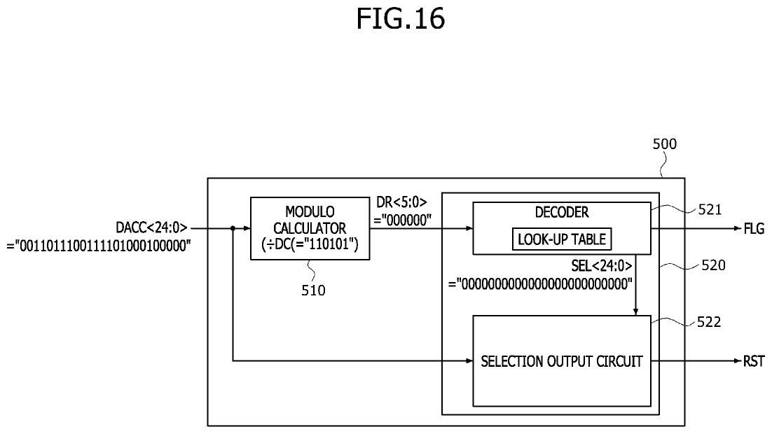

Referring to FIG. 16, the modulo calculator 510 of the error correction circuit 500 may receive the accumulative data DACC<24:0> of “0011011100111101000100000” from the accumulating circuit (400 in FIG. 15). Furthermore, the selection output circuit 522 of the error corrector 520 may receive the accumulative data DACC<24:0> of “0011011100111101000100000” that are output by the accumulating circuit (400 in FIG. 15). The modulo calculator 510 may perform a division operation of dividing the accumulative data DACC<24:0> by constant number data, that is, “110101”, and may output the remaining data DR<5:0> that are generated as the results of the division operation. The remaining data DR<5:0> may be constituted with the same 6 bits as the number of bits of the constant number data DC that is used as a multiplicand in the multiplier (120 in FIG. 10) of the data input circuit (100 in FIG. 10). In the case of this example, since the accumulative data DACC<24:0> is “0011011100111101000100000”, that is, a normal value, the remaining data DR<5:0> that is output by the modulo calculator 510 may have a binary value of “000000”.

The decoder 521 that constitutes the error corrector 520 of the error correction circuit 500 may receive the remaining data DR<5:0>“000000” that are output by the modulo calculator 510. The decoder 521 may generate the selection data SEL<24:0> based on the remaining data DR<5:0>. Since a case in which the remaining data DR<5:0> is “000000” is a case in which a computational error does not occur, the decoder 521 may generate the remaining data DR<5:0> of “0000000000000000000000000” (a decimal number 0).

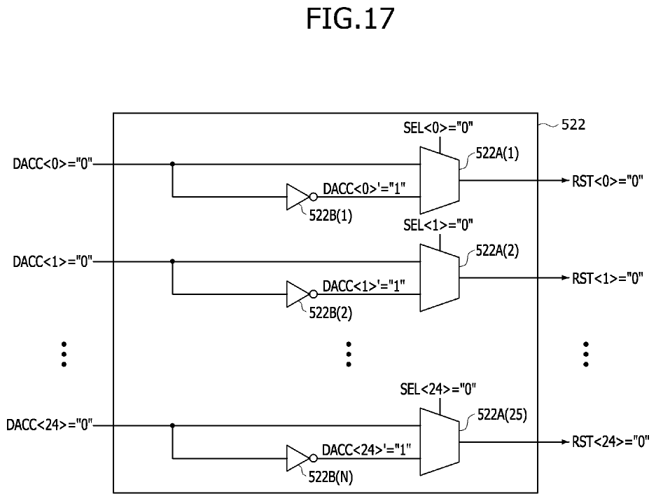

Referring to FIG. 17, the accumulative data DACC<24:0> that are transmitted by the accumulating circuit (400 in FIG. 15), that is, bits of “0011011100111101000100000”, may be transmitted to the first input terminals of the first to twenty-fifth selection outputters 522A(1) to 522A(25) that constitute the selection output circuit 522, respectively. Furthermore, the accumulative data DACC<24:0>, that is, bits of “0011011100111101000100000”, may be transmitted to the input terminals of the first to twenty-fifth inverters 522B(1) to 522B(25) that constitute the selection output circuit 522, respectively. The selection data SEL<24:0> that are output by the decoder (521 in FIG. 16), that is, bits of “0000000000000000000000000”, may be transmitted to the selection terminals of the first to twenty-fifth selection outputters 522A(1) to 522A(25), respectively.

The first inverter 522B(1) may output “1” as the inverted first bit DACC<0>′ of “0”, that is, the first bit DACC<0> of the accumulative data DACC<24:0>. The first selection outputter 522A(1) may select, as output data, the first bit DACC<0> “0” of the accumulative data DACC<24:0> that is transmitted to the first input terminal, based on the first bit SEL<0> “0” of the selection data SEL<24:0> that is transmitted through the selection terminal. Accordingly, the first selection outputter 522A(1) may output “0” as the first bit RST<0> of the MAC result data. The second inverter 522B(2) may output “1” as the inverted second bit DACC<1>′ of “0”, that is, the second bit DACC<1> of the accumulative data DACC<24:0>. The second selection outputter 522A(2) may select, as output data, the second bit DACC<1> “0” of the accumulative data DACC<24:0> that is transmitted to the first input terminal, based on the second bit SEL<1> “0” of the selection data SEL<24:0> that is transmitted through the selection terminal. Accordingly, the second selection outputter 522A(2) may output “0” as the second bit RST<1> of the MAC result data. The twenty-fifth inverter 522B(25) may output “1” as the inverted twenty-fifth bit DACC<24>′ of “0”, that is, the twenty-fifth bit DACC<24> of the accumulative data DACC<24:0>. The twenty-fifth selection outputter 522A(25) may select, as output data, the twenty-fifth bit DACC<24> “0” of the accumulative data DACC<24:0> that is transmitted to the first input terminal, based on the twenty-fifth bit SEL<24> “0” of the selection data SEL<24:0> that is transmitted through the selection terminal. Accordingly, the twenty-fifth selection outputter 522A(25) may output “0” as the twenty-fifth bit RST<24> of the MAC result data. Although not indicated in the drawings, since each of the remaining bits SEL<23:2> of the selection data has a binary value of “0”, in the same manner, the third to twenty-fourth selection outputters may output the third to twenty-fourth bits DACC<23:2> of the accumulative data DACC<24:0> as the third to twenty-fourth bits RST<23:2> of the MAC result data.

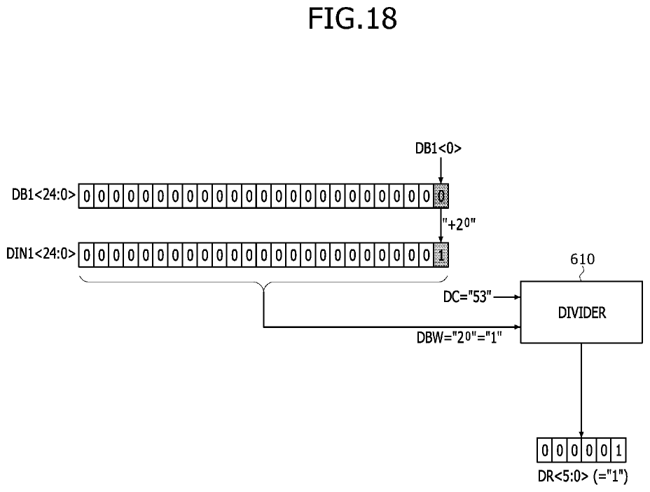

FIGS. 18 to 21 are tables illustrated to describe the first step of a process of generating a look-up table that constitutes the decoder 521 illustrated in FIG. 16. Specifically, FIGS. 18 to 21 may illustrate a process of generating a look-up table for an error (e.g., an error in which a binary value “0” is changed into a binary value “1” due to a computational error) of the first format. Hereinafter, a case in which the accumulative data DACC is constituted with 25 bits and the constant number data DC is a decimal number “53” may be taken and described as an example.

Referring to FIG. 18, in order to generate the look-up table for an error of the first format, first basic data DB1<24:0> of 25 bits which all have a binary value “0” may be set. The number of bits of the first basic data DB1<24:0> may be the same as the number of bits of the accumulative data DACC. Next, first input data DIN1<24:0> the first bit DB1<0> of which has been changed from a binary value “0” a binary value “1” may be set from the first basic data DB1<24:0>. That is, the first input data DIN1<24:0> may be constituted with “0000 0000 0000 0000 0000 0000 1”. The first input data DIN1<24:0> may have a value that has been more increased than a value of the first basic data DB1<24:0> by a binary bit weight of the first bit location, that is, by “2⁰=1”. In the present disclosure, the binary bit weight may mean a unique value corresponding to each fixed location in a binary system. The increased value of the first input data DIN1<24:0> may constitute bit weight data DBW. The bit weight data DBW “2⁰=1” may be transmitted to a first divider 610 along with the constant number data DC “53”. The first divider 610 may perform an operation of dividing the bit weight data DBW “2⁰=1” by the constant number data DC “53”. The first divider 610 may output, as the remaining data DR<5:0>, the remaining value “000001” (a decimal number “1”) that is generated as the results of the division operation.

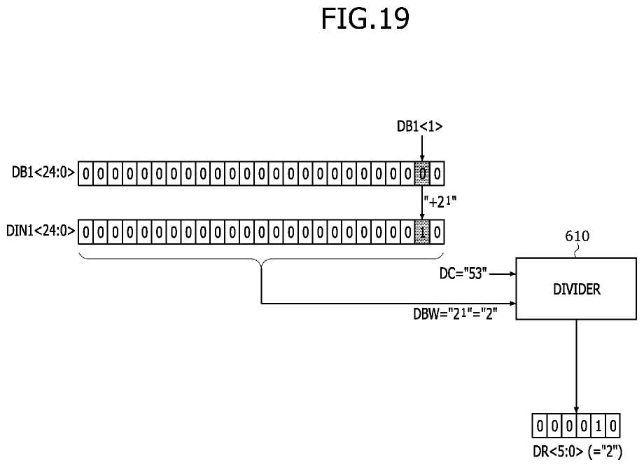

Referring to FIG. 19, the first input data DIN1<24:0> the second bit DB1<1> of which has been changed from a binary value “0” to a binary value “1” may be set from the first basic data DB1<24:0>. That is, the first input data DIN1<24:0> may be constituted with “0000 0000 0000 0000 0000 0001 0”. The first input data DIN1<24:0> may have a value that has been more increased than a value of the first basic data DB1<24:0> by “2¹=2”, that is, a binary bit weight of the second bit location. The increased value of the first input data DIN1<24:0> may constitute the bit weight data DBW. The bit weight data DBW “2¹=2” may be transmitted to the first divider 610 along with the constant number data DC “53”. The first divider 610 may perform an operation of dividing the bit weight data DBW “2¹=2” by the constant number data DC “53”. The first divider 610 may output, as the remaining data DR<5:0>, the remaining value “000010” (a decimal number “2”) that is generated as the results of the division operation.

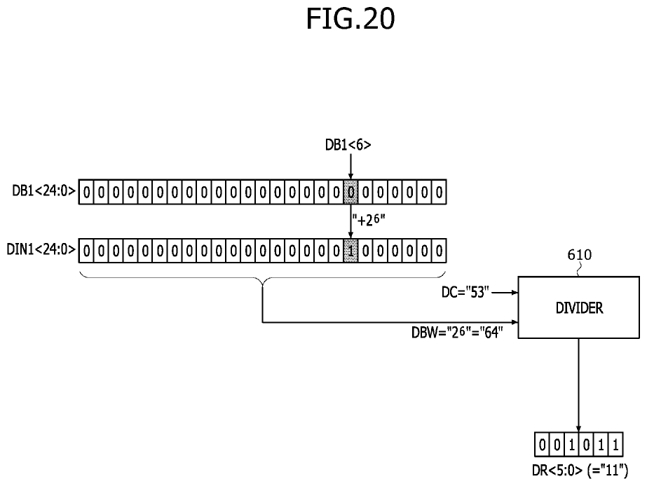

Referring to FIG. 20, the first input data DIN1<24:0> the seventh bit DB1<6> of which has been changed from a binary value “0” to a binary value “1” may be set from the first basic data DB1<24:0>. That is, the first input data DIN1<24:0> may be constituted with “0000 0000 0000 0000 0010 0000 0”. The first input data DIN1<24:0> may have a value that has been more increased than a value of the first basic data DB1<24:0> by “2⁶=64”, that is, a binary bit weight of the seventh bit location. The increased value of the first input data DIN1<24:0> may constitute the bit weight data DBW. The bit weight data DBW “2⁶=64” may be transmitted to the first divider 610 along with the constant number data DC “53”. The first divider 610 may perform an operation of dividing the bit weight data DBW “2⁶=64” by the constant number data DC “53”. The first divider 610 may output, as the remaining data DR<5:0>, the remaining value “001011” (a decimal number “11”) that is generated as the results of the division operation.

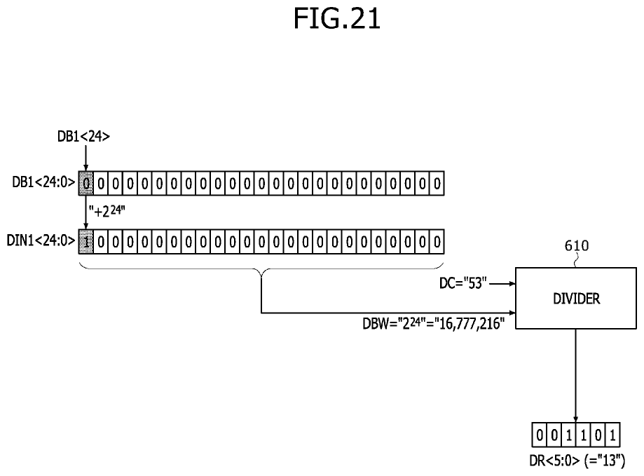

Referring to FIG. 21, the first input data DIN1<24:0> the twenty-fifth bit DB1<24> of which has been changed from a binary value “0” to a binary value “1” may be set from the first basic data DB1<24:0>. That is, the first input data DIN1<24:0> may be constituted with “1000 0000 0000 0000 0000 0000 0”. The first input data DIN1<24:0> may have a value that has been more increased than a value of the first basic data DB1<24:0> by “2²⁴=16,777,216”, that is, a binary bit weight of the twenty-fifth bit location. The increased value of the first input data DIN1<24:0> may constitute the bit weight data DBW. The bit weight data DBW “2²⁴=16,777,216” may be transmitted to the first divider 610 along with the constant number data DC “53”. The first divider 610 may perform an operation of dividing the bit weight data DBW “2²⁴=16,777,216” by the constant number data DC “53”. The first divider 610 may output, as the remaining data DR<5:0>, the remaining value “001101” (a decimal number “13”) that is generated as the results of the division operation.

Although not described with reference to the drawings, the remaining data DR<5:0> may be generated from the first basic data DB1<24:0> with respect to the first input data DIN1<24:0> each of the third to the sixth bits DB1<5:2> of which and each of the eighth to twenty-fourth bits DB1<23:7> of which has been changed from a binary value “0” to a binary value “1” by using the same methods that have been described with reference to FIGS. 18 to 21. As a result, the remaining data DR<5:0> may be extracted with respect to all the 25 cases in which one bit is changed from “0” to “1” in the first basic data DB1<24:0> all the 25 bits of which are “0”.

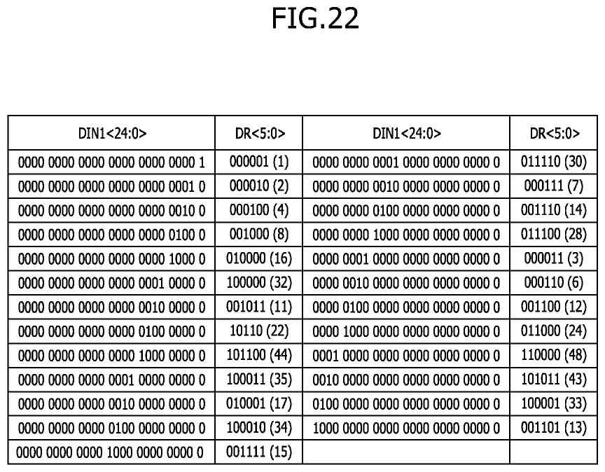

FIG. 22 is a table illustrating data that has been extracted in the process of generating a look-up table, which has been described with reference to FIGS. 18 to 21. Referring to FIG. 22, as illustrated in the table, the first input data DIN1<24:0> only one bit of which at a different location, among 25 bits, has been changed from “0” to “1”, and the remaining data DR<5:0> correspond to each other. In the case of the first input data DIN1<24:0> in which only the first bit DIN1<0> has been changed from “0” to “1”, the remaining data DR<5:0> that are extracted by the method described with reference to FIG. 18 may become “000001” (a decimal number “1”). In the case of the first input data DIN1<24:0> in which only the second bit DIN1<1> has been changed from “0” to “1”, the remaining data DR<5:0> that are extracted by the method described with reference to FIG. 19 may become “000010” (a decimal number “2”). In the case of the first input data DIN1<24:0> in which only the third bit DIN1<2> has been changed from “0” to “1”, the remaining data DR<5:0> that are extracted may become “000100” (a decimal number “4”). In the case of the first input data DIN1<24:0> in which only the fourth bit DIN1<3> has been changed from “0” to “1”, the remaining data DR<5:0> that are extracted may become “001000” (a decimal number “8”). In the case of the first input data DIN1<24:0> in which only the fifth bit DIN1<4> has been changed from “0” to “1”, the remaining data DR<5:0> that are extracted may become “010000” (a decimal number “16”). In the case of the first input data DIN1<24:0> in which only the sixth bit DIN1<5> has been changed from “0” to “1”, the remaining data DR<5:0> that are extracted may become “100000” (a decimal number “32”). In the case of the first input data DIN1<24:0> in which only the seventh bit DIN1<6> has been changed from “0” to “1”, the remaining data DR<5:0> that are extracted by the method described with reference to FIG. 20 may become “001011” (a decimal number “11”). Furthermore, in the case of the first input data DIN1<24:0> in which only the twenty-fifth bit DIN1<24> has been changed from “0” to “1”, the remaining data DR<5:0> that are extracted by the method described with reference to FIG. 21 may become “001101” (a decimal number “13”).

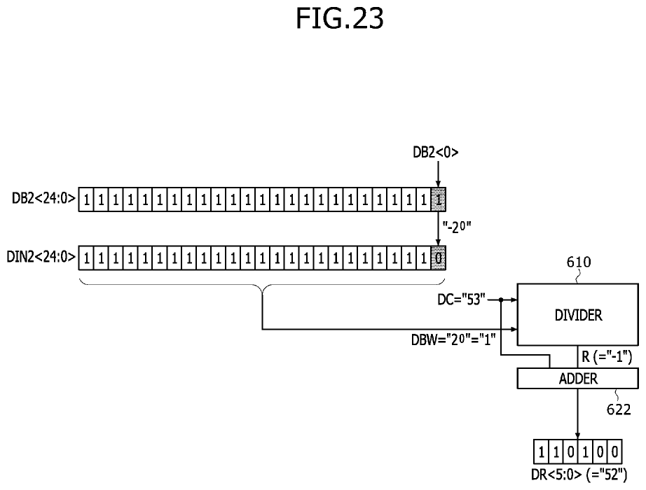

FIGS. 23 to 26 are tables illustrated to describe the second step of the process of generating a look-up table that constitutes the decoder 521 illustrated in FIG. 16. Specifically, FIGS. 23 to 26 may illustrate a process of generating a look-up table for an error of the second format (e.g., an error in which a binary value “1” is changed into a binary value “0” due to a computational error). Even in this example, a case in which the accumulative data DACC are constituted with 25 bits and the constant number data DC is a decimal number “53” may be taken and described as an example.

Referring to FIG. 23, in order to generate the look-up table for an error of the second format, second basic data DB2<24:0> of 25 bits which all have a binary value “1” may be set. The number of bits of the second basic data DB2<24:0> may be the same as the number of bits of the accumulative data DACC. Next, second input data DIN2<24:0> the first bit DB2<0> of which has been changed from a binary value “1” to a binary value “0” may be set from the second basic data DB2<24:0>. That is, the second input data DIN2<24:0> may be constituted with “1111 1111 1111 1111 1111 1111 0”. The second input data DIN2<24:0> may have a value that has been more reduced than a value of the second basic data DB2<24:0> by a binary bit weight of the first bit location, that is, “2⁰=1”. The reduced value of the second input data DIN2<24:0>, that is, “−2⁰=−1”, may constitute the bit weight data DBW. The bit weight data DBW “−2⁰=−1” may be transmitted to the second divider 621 along with the constant number data DC “53”. The second divider 621 may perform an operation of dividing the bit weight data DBW “−2⁰=−1” by the constant number data DC “53”. The second divider 621 may transmit “−1”, that is, a remainder R that is generated as the results of the division operation, to an adder 622. The adder 622 may add the remainder R “−1” and the constant number data DC “53”, and may output, as the remaining data DR<5:0>, “110100” (a decimal number “52”) that is generated as the results of the addition.

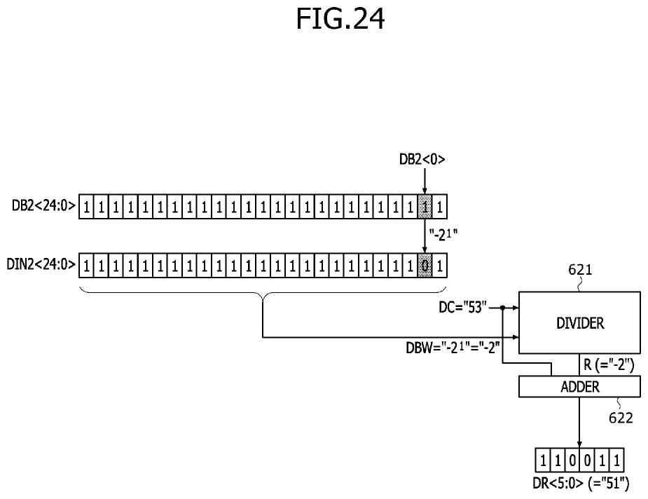

Referring to FIG. 24, the second input data DIN2<24:0> the second bit DB2<1> of which has been changed from a binary value “1” to a binary value “0” may be set from the second basic data DB2<24:0>. That is, the second input data DIN2<24:0> may be constituted with “1111 1111 1111 1111 1111 1110 1”. The second input data DIN2<24:0> may have a value that has been more reduced than a value of the second basic data DB2<24:0> by a binary bit weight of the second bit location, that is, “21=2”. The reduced value of the second input data DIN2<24:0>, that is, “−2¹=−2”, may constitute the bit weight data DBW. The bit weight data DBW “−2¹=−2” may be transmitted to the second divider 621 along with the constant number data DC “53”. The second divider 621 may perform an operation of dividing the bit weight data DBW “−2¹=−2” by the constant number data DC “53”. The second divider 621 may transmit “−2”, that is, a remainder R that is generated as the results of the division operation, to the adder 622. The adder 622 may add the remainder R “−2” and the constant number data DC “53”, and may output, as the remaining data DR<5:0>, “110011” (a decimal number “51”) that is generated as the results of the addition.

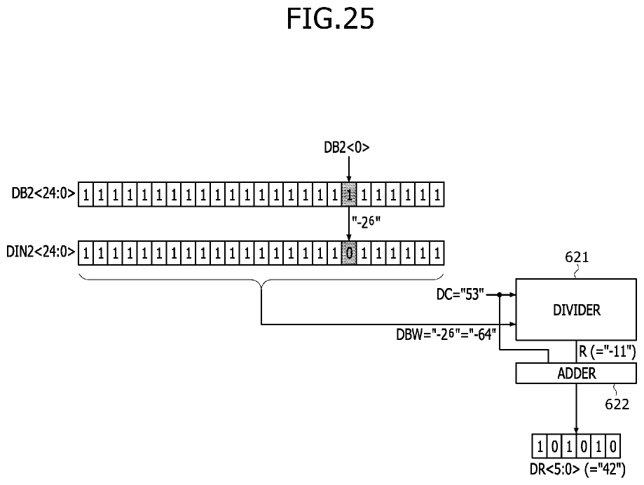

Referring to FIG. 25, the second input data DIN2<24:0> the seventh bit DB2<6> of which has been changed from a binary value “1” to a binary value “0” may be set from the second basic data DB2<24:0>. That is, the second input data DIN2<24:0> may be constituted with “1111 1111 1111 1111 1101 1111 1”. The second input data DIN2<24:0> may have a value that has been more reduced than a value of the second basic data DB2<24:0> by a binary bit weight of the seventh bit location, that is, “2⁶=2”. The reduced value of the second input data DIN2<24:0>, that is, “−2⁶=−64”, may constitute the bit weight data DBW. The bit weight data DBW “−2⁶=−64” may be transmitted to the second divider 621 along with the constant number data DC “53”. The second divider 621 may perform an operation of dividing the bit weight data DBW “−2⁶=−64” by the constant number data DC “53”. The second divider 621 may transmit “−11”, that is, a remainder R that is generated as the results of the division operation, to the adder 622. The adder 622 may add the remainder R “−11” and the constant number data DC “53”, and may output, as the remaining data DR<5:0>, “101010” (a decimal number “42”) that is generated as the results of the addition.

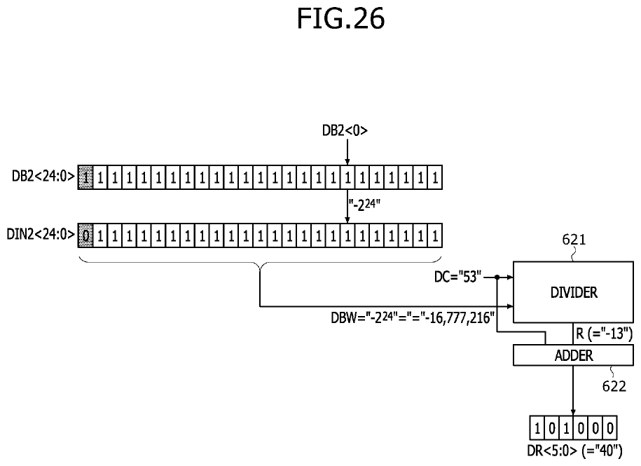

Referring to FIG. 26, the second input data DIN2<24:0> the twenty-fifth bit DB2<24> of which has been changed from a binary value “1” to a binary value “0” may be set from the second basic data DB2<24:0>. That is, the second input data DIN2<24:0> may be constituted with “0111 1111 1111 1111 1111 1111 1”. The second input data DIN2<24:0> may have a value that has been more reduced than a value of the second basic data DB2<24:0> by a binary bit weight of the twenty-fifth bit location, that is, “2²⁴=16,777,216”. The reduced value of the second input data DIN2<24:0>, that is, “−2²⁴=−16,777,216”, may constitute the bit weight data DBW. The bit weight data DBW “−2²⁴=−16,777,216” may be transmitted to the second divider 621 along with the constant number data DC “53”. The second divider 621 may perform an operation of dividing the bit weight data DBW “−2²⁴=−16,777,216” by the constant number data DC “53”. The second divider 621 may transmit “−13”, that is, a remainder R that is generated as the results of the division operation, to the adder 622. The adder 622 may add the remainder R “−13” and the constant number data DC “53”, and may output, as the remaining data DR<5:0>, “101000” (a decimal number “40”) that is generated as the results of the addition.

Although not described with reference to the drawings, the remaining data DR<5:0> may be generated from the second basic data DB2<24:0> with respect to the second input data DIN2<24:0> each of the third to the sixth bits DB2<5:2> of which and each of the eighth to twenty-fourth bits DB2<23:7> of which has been changed from a binary value “1” to a binary value “0” by using the same methods that have been described with reference to FIGS. 18 to 21. As a result, the remaining data DR<5:0> may be extracted with respect to all the 25 cases in which one bit is changed from “1” to “0” in the second basic data DB2<24:0> all the 25 bits of which are “1”.

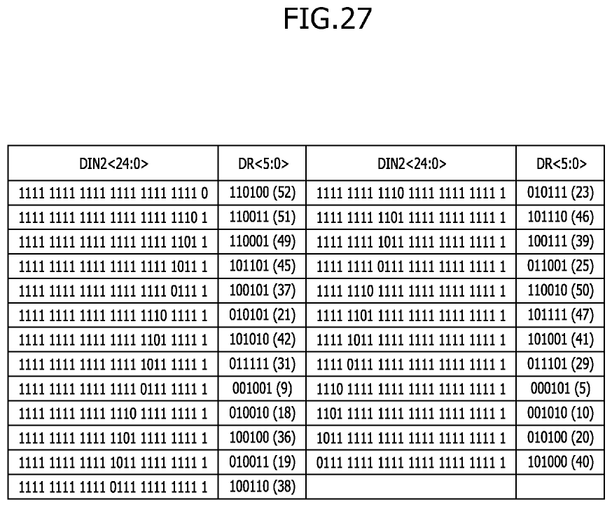

FIG. 27 is a table illustrating data that has been extracted in the process of generating a look-up table, which has been described with reference to FIGS. 23 to 26. Referring to FIG. 27, as illustrated in the table, the second input data DIN2<24:0> only one bit of which at a different location, among 25 bits, has been changed from “1” to “0” and the remaining data DR<5:0> correspond to each other. In the case of the second input data DIN2<24:0> in which only the first bit DIN2<0> has been changed from “1” to “0”, the remaining data DR<5:0> that are extracted by the method described with reference to FIG. 23 may become “110100” (a decimal number “52”). In the case of the second input data DIN2<24:0> only the second bit DIN2<1> of which has been changed from “1” to “0”, the remaining data DR<5:0> that are extracted by the method described with reference to FIG. 24 may become “110011” (a decimal number “51”). In the case of the second input data DIN2<24:0> only the third bit DIN2<2> of which has been changed from “1” to “0”, the remaining data DR<5:0> that are extracted may become “110001” (a decimal number “49”). In the case of the second input data DIN2<24:0> only the fourth bit DIN2<3> of which has been changed from “1” to “0”, the remaining data DR<5:0> that are extracted may become “101101” (a decimal number “45”). In the case of the second input data DIN2<24:0> only the fifth bit DIN2<4> of which has been changed from “1” to “0”, the remaining data DR<5:0> that are extracted may become “100101” (a decimal number “37”). In the case of the second input data DIN2<24:0> only the sixth bit DIN2<5> of which has been changed from “1” to “0”, the remaining data DR<5:0> that are extracted may become “010101” (a decimal number “21”). In the case of the second input data DIN2<24:0> only the seventh bit DIN2<6> of which has been changed from “1” to “0”, the remaining data DR<5:0> that are extracted by the method described with reference to FIG. 25 may become “101010” (a decimal number “42”). Furthermore, in the case of the second input data DIN2<24:0> only the twenty-fifth bit DIN2<24> of which has been changed from “1” to “0”, the remaining data DR<5:0> that are extracted by the method described with reference to FIG. 26 may become “101000” (a decimal number “40”).

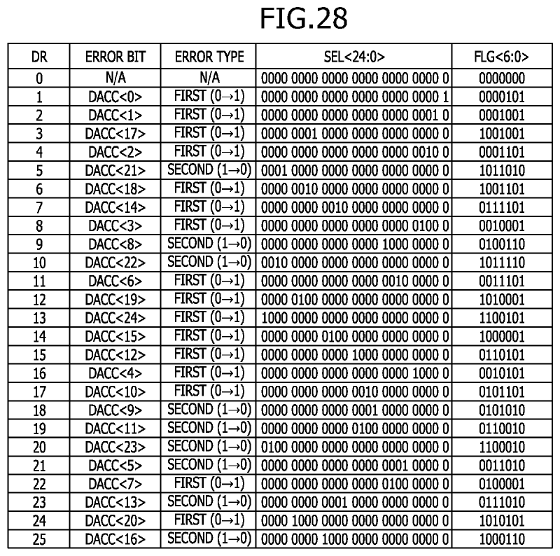

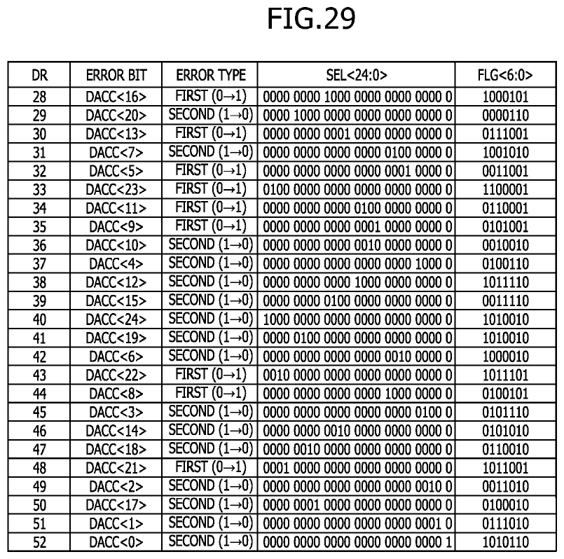

FIGS. 28 and 29 are diagrams illustrating look-up tables that are generated by the methods that have been described with reference to FIGS. 18 to 27. FIG. 28 may illustrate a look-up table when the remaining data DR is from “0” to “25”, and FIG. 29 may illustrate a look-up table when the remaining data DR is from “28” to “52”. In FIGS. 28 and 29, the remaining data DR has been indicated as a decimal value, but this is merely for the ease of a description. The remaining data DR is substantially stored in a look-up table in a binary stream format corresponding to a decimal value. If the accumulative data DACC is 25 bits and the constant number data DC is a decimal number “53”, remaining data DR “26” and “27” might not be generated.

First, as illustrated in FIG. 28, when the remaining data DR that is transmitted from the modulo calculator (510 in FIG. 6) of the error correction circuit (500 in FIG. 6) to the decoder (521 in FIG. 6) that constitutes the error corrector (520 in FIG. 6) of the error correction circuit 500 is “0”, the selection data SEL<24:0> all the bits of which are “0” and the flag data FLG<6:0> of “0000000” as defined in the look-up table may be output by the decoder 521. “00”, that is, lower 2 bits of the flag data FLG<6:0> may indicate that a computational error has not occurred. “00000”, that is, upper 5 bits of the flag data FLG<6:0>, may indicate that a computational error bit is not present. When the remaining data DR that is transmitted from the modulo calculator 510 to the decoder 521 is “1”, the selection data SEL<24:0> only the first bit, that is, the lowest of which is “1” and the remaining bits thereof are “0” and the flag data FLG<6:0> of “0000101” may be output by the decoder 521. “01”, that is, lower 2 bits of the flag data FLG<6:0>, may indicate an error of the first format, that is, an error in which normal data “0” has been changed into “1” has occurred. “00001”, that is, upper 5 bits of the flag data FLG<6:0>, may indicate that a computational error bit is the first bit DACC<0>, that is, the lowest of the accumulative data DACC.

When the remaining data DR that is transmitted from the modulo calculator 510 to the decoder 521 is “5”, the selection data SEL<24:0> only the twenty-second bit of which is “1” and all the remaining bits of which are “0” and the flag data FLG<6:0> of “1011010” may be output by the decoder 521. “10”, that is, lower 2 bits of the flag data FLG<6:0>, may indicate an error of the second format, that is, that an error in which normal data “1” has been changed into “0” has occurred. “10110”, that is, upper 5 bits of the flag data FLG<6:0>, may indicate that a computational error bit is the twenty-second bit DACC<21> of the accumulative data DACC. Similarly, when the remaining data DR that is transmitted from the modulo calculator 510 to the decoder 521 is “20”, the selection data SEL<24:0> only the twenty-fourth bit of which is “1” and all the remaining bits of which are “0” and the flag data FLG<6:0> of “1100010” may be output by the decoder 521. “10”, that is, lower 2 bits of the flag data FLG<6:0>, may indicate that an error of the second format has occurred. “11000”, that is, upper 5 bits of the flag data FLG<6:0>, may indicate that a computational error bit is the twenty-fourth bit DACC<23> of the accumulative data DACC.

As illustrated in FIG. 29, when the remaining data DR that is transmitted from the modulo calculator 510 to the decoder 521 is “28”, the selection data SEL<24:0> only the seventeenth bit of which is “1” and all the remaining bits of which are “0” and the flag data FLG<6:0> of “1000101” may be output by the decoder 521. “01”, that is, lower 2 bits of the flag data FLG<6:0>, may indicate that an error of the first format has occurred. “10001”, that is, upper 5 bits of the flag data FLG<6:0>, may indicate that a computational error bit is the seventeenth bit DACC<16> of the accumulative data DACC. As the last example, when the remaining data DR that is transmitted from the modulo calculator 510 to the decoder 521 is “52”, the selection data SEL<24:0> only the first bit of which, that is, the lowest, is “1” and all the remaining bits of which are “0” and the flag data FLG<6:0> of “1010110” may be output by the decoder 521. “10”, that is, lower 2 bits of the flag data FLG<6:0>, may indicate that an error of the second format has occurred. “10101”, that is, upper 5 bits of the flag data FLG<6:0>, may indicate that a computational error bit is the first bit DACC<0> of the accumulative data DACC.

According to the look-up tables illustrated in FIGS. 28 and 29, if the remaining data DR corresponding to a case in which an error of the first format has occurred has a value of a decimal number “A” and the remaining data DR corresponding to a case in which an error of the second format has occurred has a value of a decimal number “B” (“A” and “B” is a natural number between 1 and 52), a relation “A+B=53 (a decimal number of DC)” is established when bits at which errors have occurred in the two cases are the same. For example, if a bit at which an error has occurred is the first bit DACC<0> of accumulative data, the remaining data DR may be a decimal number “1” if an error of the first format has occurred, and the remaining data DR may be a decimal number “52” if an error of the second format has occurred. That is, if an error occurrence bit is the first bit DACC<0> of the accumulative data, the sum of the remaining data DR (the decimal number “1”) if the error of the first format has occurred and the remaining data DR (the decimal number “52”) if the error of the second format has occurred may become a decimal number “53”, that is, the constant number data DC. Furthermore, for example, if a bit at which an error has occurred is the eighth bit DACC<7> of the accumulative data, the remaining data DR may become a decimal number “22” if an error of the first format has occurred, and the remaining data DR may be a decimal number “31” if an error of the second format has occurred. That is, if an error occurrence bit is the eighth bit DACC<7> of the accumulative data, the sum of the remaining data DR (the decimal number “22”) if an error of the first format has occurred and the remaining data DR (the decimal number “31”) if an error of the second format has occurred may become a decimal number “53”, that is, the constant number data DC.

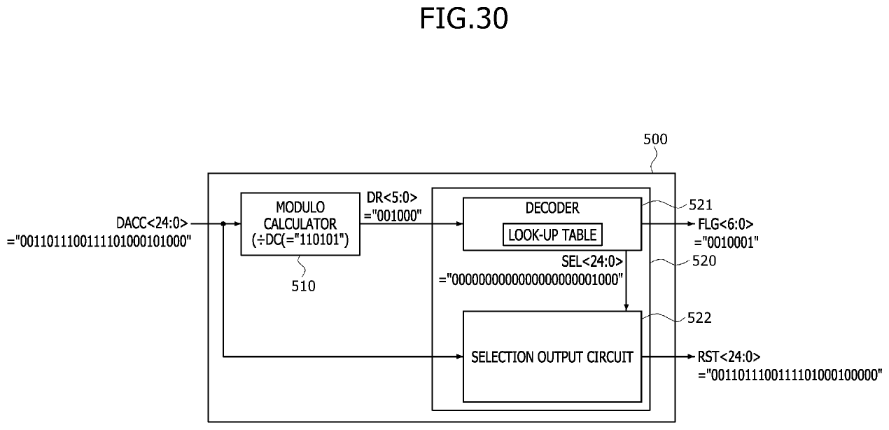

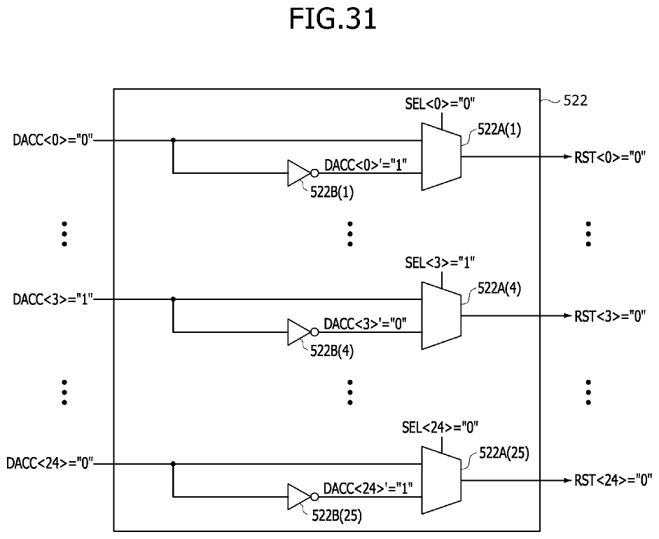

FIGS. 30 and 31 are diagrams illustrated to describe an example of a computational error correction process in the error correction circuit 500 of the MAC operator according to an example of the present disclosure. In this example, a case in which normal accumulative data DACC<24:0> in which a computational error has not occurred are “0011011100111101000100000” (a decimal number “7,240,224”) may be premised. Furthermore, a case in which accumulative data DACC<24:0>“0011011100111101000101000” (a decimal number “7,240,232”) are input from the accumulating circuit (400 in FIG. 1) to the error correction circuit 500 may be taken as an example.

First, referring to FIG. 30, the modulo calculator 510 of the error correction circuit 500 may transmit, to the decoder 521 of the error corrector 520, the remaining data DR<5:0> “001000” (a decimal number “8”) that is generated by dividing the accumulative data DACC<24:0>“0011011100111101000101000” (the decimal number “7,240,232”) by “110101” (a decimal number “53”), that is, constant number data DC. The decoder 521 may output the selection data SEL<24:0> and the flag data FLG<6:0> according to the look-up table. As illustrated in the look-up table of FIG. 28, the selection data SEL<24:0> corresponding to the remaining data DR<5:0> “001000” (the decimal number “8”) may be “0000 0000 0000 0000 0000 0100 0”, and the flag data FLG<6:0> may be “0010001”. Accordingly, the decoder 521 may output the flag data FLG<6:0>“0010001” from the error correction circuit 500, and may transmit the selection data SEL<24:0> “0000 0000 0000 0000 0000 0100 0” to the selection output circuit 522.

Referring to FIG. 31, bits of the accumulative data DACC<24:0> may be transmitted to the first input terminals of the first to twenty-fifth selection outputters 522A(1) to 522A(25) and the input terminals of the first to twenty-fifth inverters 522B(1) to 522B(25), respectively. As illustrated in FIG. 31, “0”, that is, the first bit DACC<0> of the accumulative data DACC<24:0>, may be transmitted to the first input terminal of the first selection outputter 522A(1) and the input terminal of the first inverter 522B(1). The first inverter 522B(1) may transmit “1” to the second input terminal of the first selection outputter 522A(1) as an inverted first bit DACC<0>′. “1”, that is, the fourth bit DACC<3> of the accumulative data DACC<24:0>, may be transmitted to the first input terminal of the fourth selection outputter 522A(4) and the input terminal of the fourth inverter 522B(4). The fourth inverter 522B(4) may transmit “0” to the second input terminal of the fourth selection outputter 522A(4) as an inverted fourth bit DACC<3>′. “0”, that is, the twenty-fifth bit DACC<24> of the accumulative data DACC<24:0>, may be transmitted to the first input terminal of the twenty-fifth selection outputter 522A(25) and the input terminal of the twenty-fifth inverter 522B(25). The twenty-fifth inverter 522B(25) may transmit “1” to the second input terminal of the twenty-fifth selection outputter 522A(25) as the inverted twenty-fifth bit DACC<24>′.

The first to twenty-fifth selection outputters 522A(1) to 522A(25) may receive bits of the selection data SEL<24:0> that are output by the decoder (521 in FIG. 29) through the selection terminals, respectively. Since only the fourth bit SEL<3> of the selection data SEL<24:0> “0000 0000 0000 0000 0000 0100 0” is “1” and all the remaining bits of the selection data SEL<24:0> are “0”, “1” may be input to only the selection terminal of the fourth selection outputter 522A(4) and “0” may be input to the selection terminals of the remaining first to third selection outputters 522A(1)-522A(3) and the fifth to twenty-fifth selection outputters 522A(5)-522A(25). Accordingly, the first to third selection outputters 522A(1)-522A(3) and the fifth to twenty-fifth selection outputters 522A(5)-522A(25) may output, as bits of the MAC result data RST<24:0>, bits of the accumulative data DACC<24:0> that are transmitted through the first input terminals, respectively. In contrast, the fourth selection outputter 522A(4) may output “0”, that is, an inverted bit DACC<3>′ of the accumulative data DACCN<24:0> that is transmitted through the second input terminal, as a bit of the MAC result data RST<24:0>.

Referring to FIG. 30, by the operation of the selection output circuit 522 described with reference to FIG. 31, “0011011100111101000100000” (the decimal number “7,240,224”) may be output by the selection output circuit 522 as the MAC result data RST<24:0>. Accordingly, the MAC result data RST<24:0> in which an error of the first format in which the fourth bit DACC<3> of the accumulative data DACC<24:0> is changed from “0” to “1” in an operation process has been corrected may be output by the error correction circuit 500.

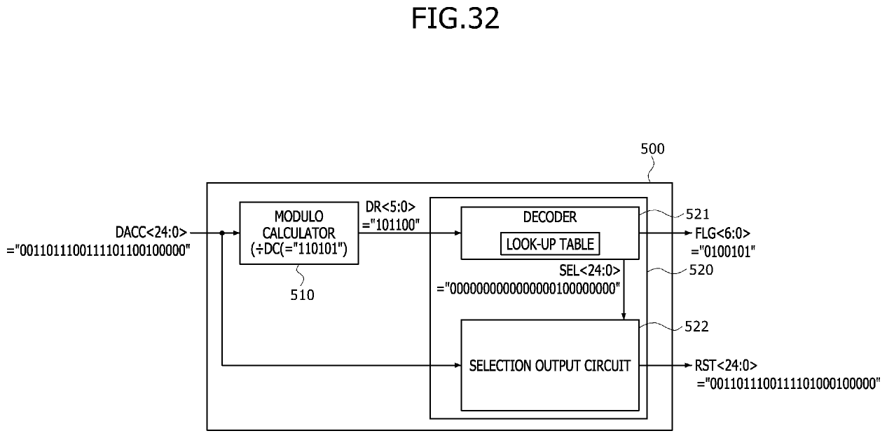

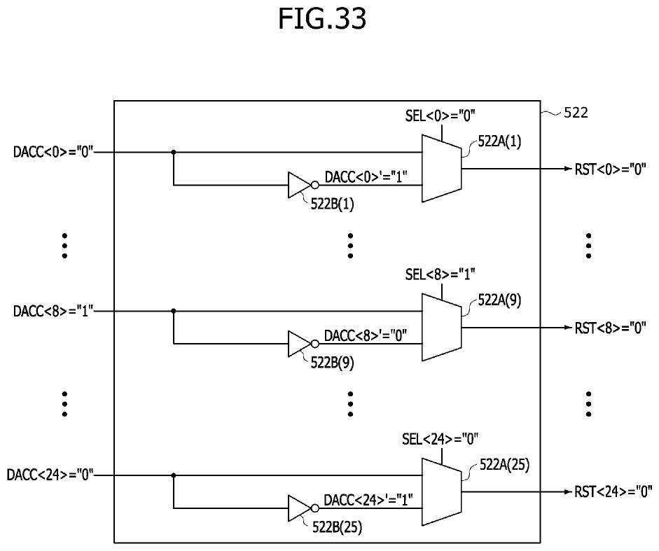

FIGS. 32 and 33 are diagrams illustrated to describe another example of a computational error correction process in the error correction circuit 500 of the MAC operator according to an example of the present disclosure. Even in this example, a case in which normal accumulative data DACC<24:0> in which a computational error has not occurred are “0011011100111101000100000” (a decimal number “7,240,224”) may be premised. Furthermore, a case in which accumulative data DACC<24:0>“0011011100111101100100000” (a decimal number “7,240,480”) are input from the accumulating circuit (400 in FIG. 1) to the error correction circuit 500 may be taken as an example.

First, referring to FIG. 32, the modulo calculator 510 of the error correction circuit 500 may transmit, to the decoder 521 of the error corrector 520, the remaining data DR<5:0> “101100” (a decimal number “44”) that are generated by dividing the accumulative data DACC<24:0>“0011011100111101100100000” (the decimal number “7,240,480”) by “110101” (a decimal number “53”), that is, the constant number data DC. The decoder 521 may output the selection data SEL<24:0> and the flag data FLG<6:0> based on the look-up table. As illustrated in the look-up table of FIG. 29, the selection data SEL<24:0> corresponding to the remaining data DR<5:0> “101100” (the decimal number “44”) may be “0000 0000 0000 0000 1000 0000 0”, and the flag data FLG<6:0> may be “0100101”. Accordingly, the decoder 521 may output the flag data FLG<6:0> “010010” from the error correction circuit 500, and may transmit the selection data SEL<24:0> “0000 0000 0000 0000 1000 0000 0” to the selection output circuit 522.

Referring to FIG. 33, bits of the accumulative data DACC<24:0> may be transmitted to the first input terminals of the first to twenty-fifth selection outputters 522A(1) to 522A(25) and the input terminals of the first to twenty-fifth inverters 522B(1) to 522B(25), respectively. As illustrated in FIG. 33, “0”, that is, the first bit DACC<0> of the accumulative data DACC<24:0> may be transmitted to the first input terminal of the first selection outputter 522A(1) and the input terminal of the first inverter 522B(1). The first inverter 522B(1) may transmit “1” to the second input terminal of the first selection outputter 522A(1) as an inverted first bit DACC<0>′. “1”, that is, the ninth bit DACC<8> of the accumulative data DACC<24:0>, may be transmitted to the first input terminal of the ninth selection outputter 522A(9) and the input terminal of the ninth inverter 522B(9). The ninth inverter 522B(9) may transmit “0” to the second input terminal of the ninth selection outputter 522A(9) as an inverted fourth bit DACC<8>′. “0”, that is, the twenty-fifth bit DACC<24> of the accumulative data DACC<24:0>, may be transmitted to the first input terminal of the twenty-fifth selection outputter 522A(25) and the input terminal of the twenty-fifth inverter 522B(25). The twenty-fifth inverter 522B(25) may transmit “1” to the second input terminal of the twenty-fifth selection outputter 522A(25) as an inverted twenty-fifth bit DACC<24>′.

The first to twenty-fifth selection outputters 522A(1) to 522A(25) may receive bits of the selection data SEL<24:0> that are output by the decoder (521 in FIG. 29) through the selection terminals, respectively. Since only the ninth bit SEL<8> of the selection data SEL<24:0> “0000 0000 0000 0000 1000 0000 0” is “1” and all the remaining bits of the selection data SEL<24:0> are “0”, “1” may be input to the selection terminal of the ninth selection outputter 522A(9), and “0” may be input to the selection terminals of the remaining first to eighth selection outputters 522A(1) to 522A(8) and the tenth to twenty-fifth selection outputters 522A(10) to 522A(25). Accordingly, the first to the eighth selection outputters 522A(1) to 522A(8) and the tenth to twenty-fifth selection outputters 522A(10) to 522A(25) may output, as bits of the MAC result data RST<24:0>, bits of the accumulative data DACC<24:0> that are transmitted through the first input terminals, respectively. In contrast, the ninth selection outputter 522A(9) may output “0”, that is, an inverted bit DACC<8>′ of the accumulative data DACCN<24:0> that is transmitted through the second input terminal, as a bit of the MAC result data RST<24:0>.

Referring back to FIG. 32, by the operation of the selection output circuit 522 described with reference to FIG. 33, “0011011100111101000100000” (the decimal number “7,240,224”) may be output by the selection output circuit 522 as the MAC result data RST<24:0>. Accordingly, the MAC result data RST<24:0> in which an error of the first format in which the ninth bit DACC<8> of the accumulative data DACC<24:0> is changed from “0” to “1” in an operation process has been corrected may be output by the error correction circuit 500.

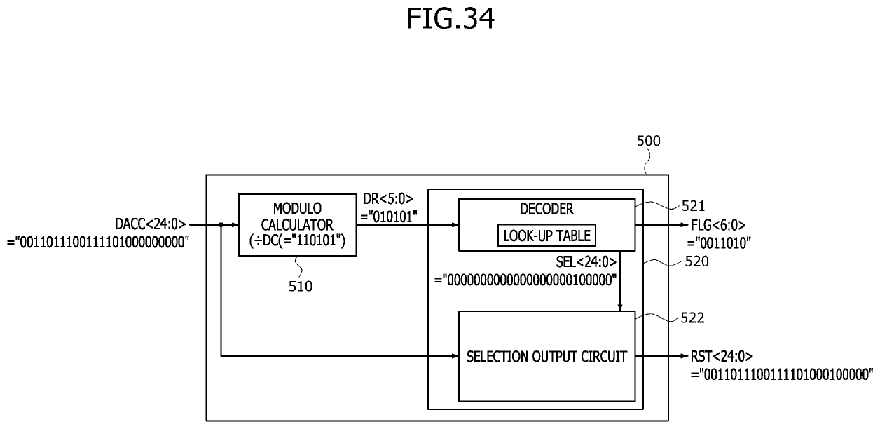

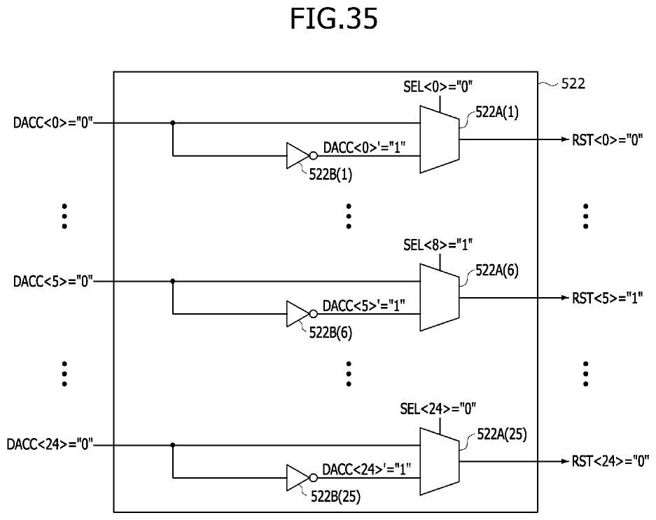

FIGS. 34 and 35 are diagrams illustrated to describe still another example of a computational error correction process in the error correction circuit 500 of the MAC operator according to an example of the present disclosure. Even in this example, a case in which normal accumulative data DACC<24:0> in which a computational error has not occurred are “0011011100111101000100000” (a decimal number “7,240,224”) may be premised. Furthermore, a case in which accumulative data DACC<24:0> “0011011100111101000000000” (a decimal number “7,240,192”) are input from the accumulating circuit (400 in FIG. 1) to the error correction circuit 500 may be taken as an example.

First, referring to FIG. 34, the modulo calculator 510 of the error correction circuit 500 may transmit, to the decoder 521 of the error corrector 520, the remaining data DR<5:0> “010101” (a decimal number “21”) that are generated by dividing the accumulative data DACC<24:0>“0011011100111101000000000” (the decimal number “7,240,192”) by constant number data DC “110101” (a decimal number “53”). The decoder 521 may output the selection data SEL<24:0> and the flag data FLG<6:0> based on the look-up table. As illustrated in the look-up table of FIG. 29, the selection data SEL<24:0> corresponding to the remaining data DR<5:0> “010101” (the decimal number “21”) may be “0000 0000 0000 0000 0001 0000 0”, and the flag data FLG<6:0> may be “0011010”. Accordingly, the decoder 521 may output the flag data FLG<6:0>“0011010” from the error correction circuit 500, and may transmit the selection data SEL<24:0> “0000 0000 0000 0000 0001 0000 0” to the selection output circuit 522.

Referring to FIG. 35, bits of the accumulative data DACC<24:0> may be transmitted to the first input terminals of the first to twenty-fifth selection outputters 522A(1) to 522A(25) and the input terminals of the first to twenty-fifth inverters 522B(1) to 522B(25), respectively. As illustrated in FIG. 35, “0”, that is, the first bit DACC<0> of the accumulative data DACC<24:0>, may be transmitted to the first input terminal of the first selection outputter 522A(1) and the input terminal of the first inverter 522B(1). The first inverter 522B(1) may transmit “1” to the second input terminal of the first selection outputter 522A(1) as an inverted first bit DACC<0>′. “0”, that is, the sixth bit DACC<5> of the accumulative data DACC<24:0>, may be transmitted to the first input terminal of the sixth selection outputter 522A(6) and the input terminal of the sixth inverter 522B(6). The sixth inverter 522B(6) may transmit “1” to the second input terminal of the sixth selection outputter 522A(6) as an inverted sixth bit DACC<5>′. “0”, that is, the twenty-fifth bit DACC<24> of the accumulative data DACC<24:0>, may be transmitted to the first input terminal of the twenty-fifth selection outputter 522A(25) and the input terminal of the twenty-fifth inverter 522B(25). The twenty-fifth inverter 522B(25) may transmit “1” to the second input terminal of the twenty-fifth selection outputter 522A(25) as an inverted twenty-fifth bit DACC<24>′.

The first to twenty-fifth selection outputters 522A(1) to 522A(25) may receive bits of the selection data SEL<24:0> that are output by the decoder (521 in FIG. 29) through the selection terminals, respectively. Since only the sixth bit SEL<5> of the selection data SEL<24:0> “0000 0000 0000 0000 0001 0000 0” is “1” and all the remaining bits of the selection data SEL<24:0> are “0”, “1” may be input to only the selection terminal of the sixth selection outputter 522A(6), and “0” may be input to the selection terminals of the remaining first to fifth selection outputters 522A(1) to 522A(5) and the seventh to twenty-fifth selection outputters 522A(7) to 522A(25). Accordingly, the first to fifth selection outputters 522A(1) to 522A(5) and the seventh to twenty-fifth selection outputters 522A(7) to 522A(25) may output, as bits of the MAC result data RST<24:0>, bits of the accumulative data DACC<24:0> that are transmitted through the first input terminals, respectively. In contrast, the sixth selection outputter 522A(6) may output “1”, that is, the inverted bit DACC<5>′ of the accumulative data DACCN<24:0> that is transmitted through the second input terminal, as a bit of the MAC result data RST<24:0>.

Referring back to FIG. 34, by the operation of the selection output circuit 522 described with reference to FIG. 33, “0011011100111101000100000” (the decimal number “7,240,224”) may be output by the selection output circuit 522 as the MAC result data RST<24:0>. Accordingly, the MAC result data RST<24:0 in which an error of the second format in which the sixth bit DACC<5> of the accumulative data DACC<24:0> is changed from “1” to “0” in an operation process has been corrected may be output by the error correction circuit 500.

A limited number of possible embodiments for the present teachings have been presented above for illustrative purposes. Those of ordinary skill in the art will appreciate that various modifications, additions, and substitutions are possible. While this patent document contains many specifics, these should not be construed as limitations on the scope of the present teachings or of what may be claimed, but rather as descriptions of features that may be specific to particular embodiments. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A multiplication and accumulation (MAC) operator comprising:
a data input circuit configured to receive first operands and second operands and configured to output the first operands and third operands;
a multiplication circuit configured to generate multiplication data by performing a multiplication operation on the first operands and the third operands;
an addition circuit configured to generate multiplication addition data by performing an addition operation on the multiplication data;
an accumulating circuit configured to generate accumulative data by performing an accumulative addition operation on the multiplication addition data and feedback data; and
an error correction circuit configured to detect a computational error in the accumulative data when a computational error occurs, and configured to output, as MAC result data, accumulative data having the computational error corrected.

2. The MAC operator of claim 1, wherein the third operands are generated by the data input circuit by multiplying the second operands by constant number data, respectively.

3. The MAC operator of claim 2, wherein the data input circuit comprises:
a first register circuit configured to store the first operands and configured to transmit the first operands to the multiplication circuit in response to an input of a MAC signal having a first logic level;
a multiplier configured to generate the third operands by performing a multiplication operation on the second operands and the constant number data, respectively; and
a second register circuit configured to store the third operands and configured to transmit the third operands to the multiplication circuit in response to the input of the MAC signal having the first logic level.

4. The MAC operator of claim 1, wherein the error correction circuit is configured to output, as the MAC result data, the accumulative data that are output by the accumulating circuit when the computational error does not occur.

5. The MAC operator of claim 1, wherein the error correction circuit is configured to output flag data indicative of a bit location at which the computational error has occurred and a format of the computational error.

6. The MAC operator of claim 1, wherein:
the third operands are generated by the data input circuit by multiplying the second operands by constant number data, respectively, and
the error correction circuit comprises:
a modulo calculator configured to output remaining data that are generated by dividing the accumulative data by the constant number data; and
an error corrector configured to perform a detection operation on the computational error of the accumulative data and a correction operation on the accumulative data having the computational error based on the remaining data.

7. The MAC operator of claim 6, wherein the error corrector comprises:
a decoder configured to generate selection data based on the remaining data; and
a selection output circuit configured to output a bit that is selected by the selection data, among bits of the accumulative data, by inverting the bit that is selected.

8. The MAC operator of claim 7, wherein the decoder is configured to generate the selection data by using a look-up table.

9. The MAC operator of claim 8, wherein:
the look-up table has first to fourth columns,
the remaining data are disposed in the first column,
a bit at which the computational error has occurred is disposed in the second column,
a computational error format is disposed in the third column, and
the selection data is disposed in the fourth column.

10. The MAC operator of claim 9, wherein the computational error format that is disposed in the look-up table comprises:
a first format in which one of the bits of the accumulative data is changed from a normal value “0” to “1”; and
a second format in which one of the bits of the accumulative data is changed from a normal value “1” to “0”.

11. The MAC operator of claim 10,
wherein in the look-up table, an error occurrence bit including the first format and an error occurrence bit including the second format are identically written when a result of “A+B” has a value identical with a value of the constant number data, when the remaining data corresponding to a case in which an error having the first format has occurred has a value of a decimal number “A” and the remaining data corresponding to a case in which an error having the second format has occurred has a value of a decimal number “B”, and
wherein each of “A” and “B” is a natural number that belongs to 1−(the remaining data−1.

12. The MAC operator of claim 9, wherein only a bit at which the computational error has occurred, among the selection data that are disposed in the look-up table is a binary value “1”, and all of remaining bits of the selection data that are disposed in the look-up table are constituted with “0”.

13. The MAC operator of claim 9, wherein the look-up table further comprises a fifth column in which flag data indicative of a bit location at which the computational error has occurred and a format of the computational error are disposed.

14. The MAC operator of claim 8, wherein the look-up table is written by
setting first input data in which only one bit is changed into “1” in first basic data all bits of which are “0” and extracting, as the remaining data, a remaining value that is generated as a result of an operation of dividing a binary bit weight of the changed bit by the constant number data, and
setting second input data in which only one bit is changed into “0” in second basic data all bits of which are “1” and extracting, as the remaining data, a result value of an addition of a remaining value that is generated as a result of an operation of dividing a binary bit weight of the changed bit by the constant number data and the constant number data.

15. The MAC operator of claim 7, wherein the selection output circuit comprises:
a plurality of inverters configured to receive the bits of the accumulative data, respectively; and
a plurality of selection outputters configured to receive the bits of the accumulative data through first input terminals, respectively, configured to receive output data of the plurality of inverters through second input terminals, respectively, configured to receive bits of the selection data through selection terminals, respectively, and configured to output bits of the output data through output terminals, respectively.

16. The MAC operator of claim 15, wherein each of the plurality of selection outputters is configured to
output a bit of the accumulative data as a bit of the output data when a bit of the selection data that is transmitted to the selection terminal is “0”, and
output an inverted bit of a bit of the accumulative data as a bit of the output data when a bit of the selection data that is transmitted to the selection terminal is “1”.
